(19) United States
(12) Patent Application Publication
(10) Pub. No.: US 2005/0264496 A1
(43) Pub. Date: Dec. 1, 2005

(54) Display and driving method thereof

(76) Inventor: Dong-Yong Shin, Suwon-si (KR)

Correspondence Address: CHRISTIE, PARKER & HALE, LLP, PO BOX 7068, PASADENA, CA, 91109-7068, US

(21) Appl. No.: 11/128,924

(22) Filed: May 13, 2005

(30) Foreign Application Priority Data
May 25, 2004 (KR) 10-2004-0037266
May 28, 2004 (KR) 10-2004-0038260
May 28, 2004 (KR) 10-2004-0038261

(51) Int. Cl. G09G 3/30

(52) U.S. Cl. 345/76

(57) ABSTRACT

In an organic light emitting display, a first pixel and a second pixel share a data line, a select scan line, and a driving element, and a field is divided into first and second subfields. An organic light emitting element of the first pixel is driven by a first emission control signal transmitted to a first emit scan line, and an organic light emitting element of the first pixel is driven by a second emission control signal transmitted to a second emit scan line. The first emission control signal has a low-level pulse in the first subfield, the second emission control signal has a low-level pulse in the second subfield, and a select signal transmitted to the select scan line has a low-level pulse in each of the first and second subfields. In addition, a scan driver for driving the select signal line, the first emit scan line, and the second emit scan line is provided.

### CROSS REFERENCE TO RELATED APPLICATION

This application claims priority to and the benefit of Korean Patent Applications No. 10-2004-0037266 filed on May 25, 2004 and Nos. 10-2004-0038260 and 10-2004-0038261 respectively filed on May 28, 2004 in the Korean Intellectual Property Office, the entire contents of which are incorporated herein by reference.

### BACKGROUND OF THE INVENTION

(a) Field of the Invention

The present invention relates to a display and a driving method thereof.

(b) Description of the Related Art

In a display area of an active matrix display such as a liquid crystal display and an organic light emitting display, scan lines extended in a row direction and data lines extended in a column direction are formed. Two adjacent scan lines and two adjacent data lines define a pixel area, and a pixel is formed on the pixel area. An active element such as a transistor is formed on the pixel and transmits a data signal from the data line in response to a select signal from the scan line. Therefore, the active matrix display needs a scan driver for driving the scan lines and a data driver for driving the data lines.

In the active matrix display, colors are represented through combinations of colors emitted by certain pixels. In general, the pixels include pixels for displaying red, pixels for displaying green, and pixels for displaying blue, and the colors are displayed by combinations of red, green, and blue. In the display, the pixels are arranged in an order of red, green, and blue along a row direction, and data lines are respectively coupled to pixels arranged along the row direction.

Since a data driver converts the data signals to analog voltages or analog currents and applies those to all data lines, the data driver has many output terminals corresponding to the data lines. Generally, the data driver is manufactured in the form of an integrated circuit. However, a plurality of integrated circuits are used to drive all data lines since the number of output terminals which an individual integrated circuit has is limited. In addition, if the data line and driving elements are formed on each pixel, the aperture ratio corresponding to a light emission area of the pixel is reduced.

### SUMMARY OF THE INVENTION

In an exemplary embodiment of the present invention, a display having a reduced number of the integrated circuits for driving data lines is provided.

In another exemplary embodiment of the present invention, a display having a reduced number of the data lines is provided.
In another exemplary embodiment of the present invention, two pixels share a data line and a scan line.

In one aspect of the present invention, a display includes a display area and a scan driver. The display area includes a plurality of data lines for transmitting data signals for displaying an image, a plurality of first scan lines for transmitting select signals, a plurality of second scan lines and a plurality of third scan lines for respectively transmitting emission control signals, and a plurality of pixel areas. A pixel area includes a first pixel and a second pixel coupled to the corresponding data line and the corresponding first scan line. The first pixel emits light in response to the second pulse and the second pixel emits light in response to the third pulse. The scan driver transmits first signals to the first scan lines by shifting the first signal, transmits second signals to the second scan lines by shifting the second signal, and transmits third signals to the third scan lines by shifting the third signal. The first signal has a first pulse in each of a plurality of subfields for forming a field, the second signal has a second pulse in a first subfield of the plurality of subfields, and the third signal has a third pulse in a second subfield of the plurality of subfields.

In another aspect of the present invention, a display device includes a plurality of first scan lines transmitting a plurality of first signals, a plurality of second scan lines transmitting a plurality of second signals, and a plurality of third scan lines transmitting a plurality of third signals. The display further includes a first driver, a second driver, and a third driver. The first driver outputs the first signals by shifting the first signal by a first period, the second driver outputs the second signals by shifting the second signal by the first period, and the third driver outputs the third signals by shifting the third signal by the first period. The first signal has a first pulse during a second period in each of a plurality of subfields forming a field, the second signal has a second pulse during a third period longer than the second period in a first subfield of the plurality of subfields, and the third signal has a third pulse during a fourth period longer than the second period in a second subfield of the plurality of subfields.

In still another aspect of the present invention, a display includes a plurality of first scan lines transmitting a plurality of first signals, a plurality of second scan lines transmitting a plurality of second signals, and a plurality of third scan lines transmitting a plurality of third signals. The display further includes a first driver and a second driver. The first driver outputs the first signals by shifting the first signal by a first period. The second driver generates the second signal and the third signal from a fourth signal. In addition, the second driver outputs the second signals by shifting the second signal by the first period, and outputs the third signals by shifting the third signal by the first period. The first signal has a first pulse during a second period in each of a plurality of subfields forming a field. The second signal has a second pulse during a third period longer than the second period in a first subfield of the plurality of subfields, and the third signal has a third pulse during a fourth period longer than the second period in a second subfield of the plurality of subfields from a fourth signal.

In a further aspect of the present invention, a scan driver outputs first signals by shifting the first signal by a first period, outputs second signals by shifting the second signal by the first period, and outputs third signals by shifting the first signal by the first period. The scan driver includes a first driver and a second driver. The first driver outputs fourth signals by shifting the fourth signal by the first period, and the fourth signal has a first pulse and a second pulse inverted to the first pulse in a field. The second driver generates the first signal having a third pulse during a second period in each of a plurality of subfields forming a field, the second signal having a fourth pulse during a third period longer than the second period in a first subfield of the plurality of subfields, and the third signal having a fifth pulse during a fourth period longer than the second period in a second subfield of the plurality of subfields, from a fourth signal.

In a still further aspect of the present invention, a display includes a first scan line, a second scan line, a third scan line, a data line transmitting a data signal for displaying an image, and a pixel area defined by the first, second, and third scan lines, and the data line. A driving method of the display includes outputting a select signal having a first pulse during a first period in each of a plurality of subfields forming a field, outputting a first emission control signal having a second pulse during a second period longer than the first period in a first subfield of the plurality of subfields, and outputting a second emission control signal having a third pulse during a third period longer than the first period in a second subfield of the plurality of subfields. The data signal is programmed to the pixel area in response to a pulse corresponding to the first pulse transmitted to the first scan line. A first pixel of the pixel area starts emitting light corresponding to the programmed data signal in response to a pulse corresponding to the second pulse transmitted to the second scan line, and a second pixel of the pixel area starts emitting light corresponding to the programmed data signal in response to a pulse corresponding to the third pulse transmitted to the third scan line.

### BRIEF DESCRIPTION OF THE DRAWINGS

FIG. 1 shows a plan view of an organic light emitting display according to a first exemplary embodiment of the present invention.

FIG. 2 shows a schematic diagram of pixel areas of the organic light emitting display according to the first exemplary embodiment of the present invention.

FIG. 3 shows a signal timing diagram of the organic light emitting display according to the first exemplary embodiment of the present invention.

FIG. 4A shows a select scan driver in the organic light emitting display according to the first exemplary embodiment of the present invention.

FIG. 4B shows a flip-flop used in the select scan driver of FIG. 4A.

FIG. 5 shows a signal timing diagram in the select scan driver of FIG. 4A.

FIGS. 6, 9, and 11 show emit scan drivers in the organic light emitting displays according to second, third, and fourth exemplary embodiments of the present invention, respectively.

FIG. 7 shows a schematic diagram of pixel areas of the organic light emitting display according to the second exemplary embodiment of the present invention.

FIG. 8 shows a signal timing diagram of the organic light emitting display according to the second exemplary embodiment of the present invention.

FIGS. 10 and 12 show signal timing diagrams in the emit scan drivers of FIGS. 9 and 11, respectively.

FIGS. 13 and 14 show plan views of organic light emitting displays according to fourth and fifth exemplary embodiments of the present invention, respectively.

FIGS. 15, 16, and 18 show emit scan drivers in the organic light emitting displays according to fifth, sixth, and seventh exemplary embodiments of the present invention, respectively.

FIG. 17 shows a signal timing diagram in the emit scan driver of FIG. 16.

FIGS. 19 and 20 show signal timing diagrams in the emit scan driver of FIG. 18, respectively.

FIGS. 21 and 22 show plan views of organic light emitting displays according to eighth and ninth exemplary embodiments of the present invention, respectively.

FIGS. 23, 25, 26, and 28 show scan drivers in the organic light emitting displays according to ninth, tenth, eleventh, and twelfth exemplary embodiments of the present invention, respectively.

FIGS. 24 and 27 show signal timing diagrams in the scan drivers of FIGS. 23 and 26, respectively.

FIG. 29 shows a signal timing diagram in a scan driver according to a thirteenth exemplary embodiment of the present invention.

FIGS. 30 and 32 show scan drivers in the organic light emitting displays according to fourteenth and fifteenth exemplary embodiments of the present invention, respectively.

FIG. 31 shows a signal timing diagram in the scan driver of FIG. 30.

FIG. 33 shows a plan view of an organic light emitting display according to a sixteenth exemplary embodiment of the present invention.

FIG. 34 shows a signal timing diagram in a select scan driver according to a seventeenth exemplary embodiment of the present invention.

### DETAILED DESCRIPTION

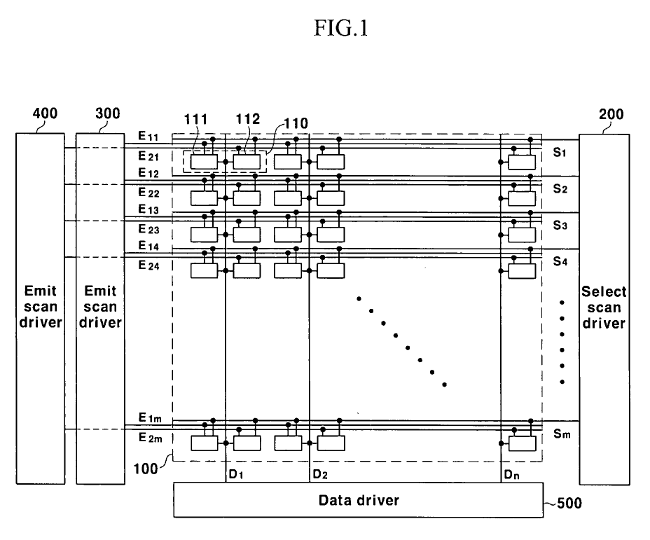

Referring now to FIG. 1, an organic light emitting display includes a substrate (not shown) for forming a display panel, and the substrate is divided into a display area 100 seen as a screen to a user and a peripheral area surrounding the display area 100. The peripheral area includes a select scan driver 200, emit scan drivers 300, 400, and a data driver 500.

The display area 100 includes a plurality of data lines D₁ to Dₙ, a plurality of select scan lines S₁ to Sₘ, a plurality of emit scan lines E₁₁ to E₁ₘ and E₂₁ to E₂ₘ, and a plurality of pixels. The data lines D₁ to Dₙ are extended in a column direction and transmit data signals representing images to the corresponding pixels. The select scan lines S₁ to Sₘ and the emit scan lines E₁₁ to E₁ₘ and E₂₁ to E₂ₘ are extended in a row direction and transmit select signals and emission control signals to the corresponding pixels, respectively. The pixel area 110 is defined by two adjacent scan lines S₁ to Sₘ and two adjacent data lines D₁ to Dₘ, and two pixels 111, 112 are formed on the pixel area 110. That is, two pixels 111, 112 of the pixel area 110 are coupled to one of the data lines D₁ to Dₘ and one of the select scan lines S₁ and Sₘ in common.

The select scan driver 200 sequentially transmits select signals for selecting corresponding lines to the select scan lines S₁ to Sₘ in order to apply data signals to pixels of the corresponding lines. The emit scan driver 300 sequentially transmits emission control signals for controlling light emission of pixels 111 to the emit scan lines E₁₁ to E₁ₘ in one subfield, and the emit scan driver 400 sequentially transmits emission control signals for controlling light emission of pixels 112 to the emit scan lines E₂₁ to E₂ₘ in the other subfield. The data driver 500 applies data signals corresponding to the pixels of lines to which select signals are applied to the data lines D₁ to Dₘ each time the select signals are sequentially applied.

The select and emit scan drivers 200, 300, 400 and the data driver 500 are coupled to the substrate. In addition, the select and emit scan drivers 200, 300, and/or 400 and/or the data driver 500 can be installed directly on the substrate, and they can be substituted with a driving circuit which is formed on the same layer on the substrate as the layer on which scan lines, data lines, and transistors are formed. Further, the select and emit scan drivers 200, 300, and/or 400 and/or the data driver 500 can be installed in a chip format on a tape carrier package (TCP), a flexible printed circuit (FPC), or a tape automatic bonding unit (TAB) coupled to the substrate.

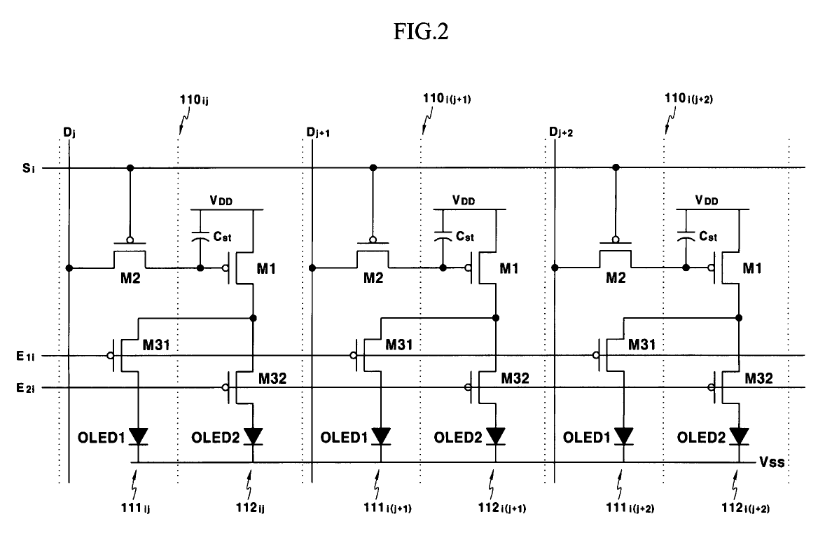

FIG. 2 shows a schematic diagram of the pixel areas of the organic light emitting display of FIG. 1. The three pixel areas 110ᵢⱼ, 110ᵢ₍ⱼ₊₁₎, 110ᵢ₍ⱼ₊₂₎ coupled to the scan line Sᵢ of the i^{th} row (where ‘i’ is an positive integer less than ‘m’) and the data lines Dⱼ to Dⱼ₊₂ of the j^{th} to (j+2)^{th} columns (where ‘j’ is an positive integer less than ‘n’) will be exemplified in FIG. 2. It is assumed that the pixels are arranged in an order of red, green, and blue along the row direction in FIG. 2.

Referring to FIG. 2, the two pixels 111, 112 have one of the data lines D₁ to Dₙ and a pixel driver in common, and the pixel driver includes a driving transistor M1, a switching transistor M2, and a capacitor Cst. The two pixels 111ᵢⱼ, 111ᵢⱼ of the pixel area 110ᵢⱼ defined by the i^{th} select scan line Sᵢ and the j^{th} data line Dⱼ include the pixel driver, two emit transistors M31, M32, and two organic light emitting elements OLED1, OLED2. The organic light emitting elements OLED1, OLED2 emit light red and green lights, respectively. The organic light emitting elements emit light having a brightness corresponding to the applied current. The two pixels 111ᵢ₍ⱼ₊₁₎, 112ᵢ₍ⱼ₊₁₎ of the pixel area 110ᵢ₍ⱼ₊₁₎ defined by the i^{th} select scan line Sᵢ and the (j+1)^{th} data line Dⱼ₊₁, and the two pixels 111ᵢ₍ⱼ₊₂₎, 112ᵢ₍ⱼ₊₂₎ of the pixel area 110ᵢ₍ⱼ₊₂₎ defined by the i^{th} select scan line Sᵢ and the (j+2)^{th} data line Dⱼ₊₂ have the same structures as the pixels 111ᵢⱼ, 112ᵢⱼ. The organic light emitting elements OLED1, OLED2 of the two pixels 111ᵢ₍ⱼ₊₁₎, 112ᵢ₍ⱼ₊₂₎ emit light blue and red lights, respectively, and the organic light emitting elements OLED1, OLED2 of the two pixels 111ᵢ₍ⱼ₊₂₎, 112ᵢ₍ⱼ₊₂₎ emit light green and blue lights, respectively.

In more detail, the driving transistor M1 has a source coupled to the power line VDD for supplying a power supply voltage, and has a gate coupled to a drain of the switching transistor M2, and a capacitor Cst is coupled between a source and a gate of the driving transistor M1. The switching transistor M2 having a gate coupled to the select scan line Sᵢ and a source coupled to the data line Dⱼ transmits the data signal converted to analog voltage (hereinafter, “data voltage”) provided by the data line Dⱼ in response to the select signal provided by the select scan line Sᵢ. The driving transistor M1 has a drain coupled to sources of emit transistors M31, M32, and gates of the emit transistors M31, M32 are coupled to the emission control signal lines E₁ᵢ, E₂ᵢ, respectively. Drains of the emit transistors M31, M32 are coupled, respectively, to anodes of the organic light emitting elements OLED1, OLED2, and a power supply voltage VSS is applied to cathodes of the organic light emitting elements OLED1, OLED2. The power supply voltage VSS in the first exemplary embodiment can be a negative voltage or a ground voltage.

The switching transistor M2 transmits the data voltage provided by the data line Dⱼ to the gate of the driving transistor M1 in response to a low-level select signal provided by the select scan line Sᵢ, and the voltage which corresponds to a difference between the data voltage transmitted to the gate of the transistor M1 and the power supply voltage VDD is stored in the capacitor Cst. When the emit transistor M31 is turned on in response to a low-level emission control signal provided by the emission control signal line E₁ᵢ, the current I_{OLED}, which corresponds to the voltage stored in the capacitor Cst as expressed in Equation 1 below, is transmitted to the organic light emitting element OLED1 from the driving transistor M1 to emit light. In a like manner, when the emitting transistor M32 is turned on in response to a low-level emission control signal provided by the emission control signal line E₂ᵢ, the current which corresponds to the voltage stored in the capacitor Cst is transmitted to the organic light emitting element OLED2 from the driving transistor M1 to emit light. Two emission control signals applied to the low emission control signal lines E₁ᵢ, E₂ᵢ respectively have low-level periods without repetition during one field so that one pixel area can display two colors.

$${I}_{OLED} = \frac{β}{2} {( \vert {V}_{SG} \vert - \vert {V}_{TH} \vert )}^{2} \qquad Equation 1$$

where β is a constant determined by a channel width and a channel length of the transistor M1, V_{SG} is a voltage between source and gate of the transistor M1, and V_{TH} is a threshold voltage of the transistor M1.

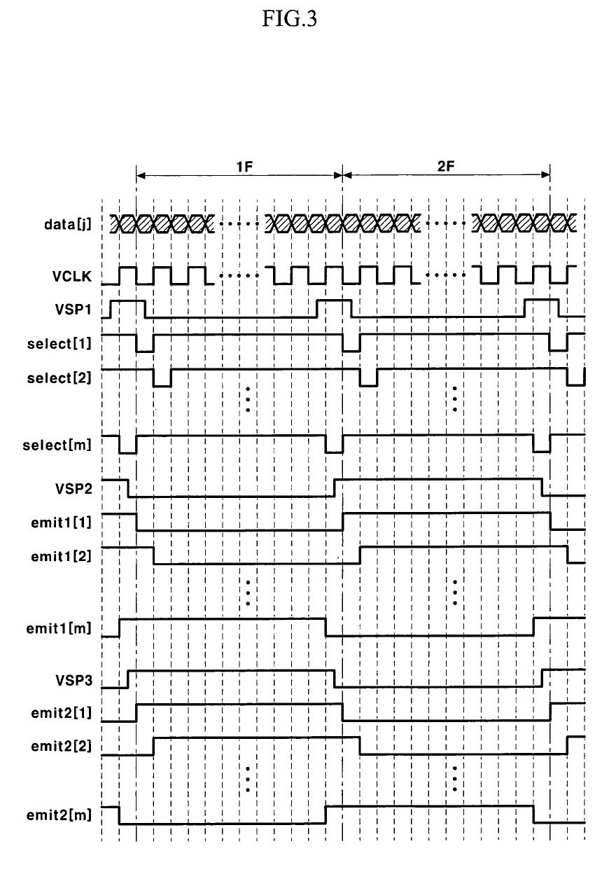

A driving method of the organic light emitting display according to the first exemplary embodiment of the present invention will be described in more detail with reference to FIG. 3. In FIG. 3, the select signal applied to the select scan line Sᵢ is depicted as ‘select[i]’, and the emission control signals applied to the emit scan lines E₁ᵢ, E₂ᵢ are depicted as ‘emit1[i]’, ‘emit2[i]’, respectively. The data voltage data[j] applied to the data line Dⱼ is depicted in FIG. 3 since the data voltages are simultaneously applied to the data lines D₁ to Dₙ.

Referring to FIG. 3, one field includes two subfields 1F, 2F, and the low-level select signals are sequentially applied to the select scan lines S₁ to Sₘ in each subfield 1F or 2F. The two organic light emitting elements OLED1, OLED2 of the two pixels sharing the pixel driver emit light during periods corresponding to subfields SF1, SF2, respectively.

In the subfield 1F, when a low-level select signal select[1] is applied to the select scan line S₁ on the first row, a data voltage data[j] corresponding to the organic light emitting element OLED1 of the each pixel area on the first row is applied to the corresponding data line Dⱼ, and a low-level emission control signal emit1[1] is applied to the emission control signal line E₁ᵢ on the first row. The emit transistor M31 of the pixel area on the first row is turned on, and a current corresponding to the data voltage data[j] is transmitted to the organic light emitting element OLED1 from the driving transistor M1 to thus emit light. The light is emitted during the period in which the emission control signal emit1[1] is low-level, and the low-level period of the emission control signal emit1[1] is the same as the period which corresponds to the subfield 1F.

In a like manner, the data voltages are sequentially applied to pixel areas of from the first to m^{th} rows to emit the organic light emitting element OLED1. When a low-level select signal select[i] is applied to the select scan line Sᵢ on the i^{th} row, the data voltage data[j] corresponding to the organic light emitting element OLED1 of the each pixel area of the i^{th} row are applied to the corresponding data line Dⱼ, and a low-level emission control signal emit1[i] is applied to the emission control signal line E₁ᵢ of the i^{th} row. A current corresponding to the data voltage data[j] provided by each of the data lines Dⱼ is accordingly supplied to the organic light emitting element OLED1 of the corresponding pixel area on the i^{th} row to thus emit light during the period which corresponds to the subfield 1F. Therefore, in the subfield 1F, the pixel on which the organic light emitting element OLED1 is formed emits light in the two pixels which are adjacent in the row direction.

In the subfield 2F, in a like manner as in the subfield 1F, a low-level select signal select[1] to select[m] is sequentially applied to the select scan lines S₁ to Sₘ of from the first to the m^{th} rows, and when the select signal select[i] is applied to the corresponding select scan line Sᵢ, the data voltage data[j] corresponding to the organic light emitting element OLED2 of each pixel area of the corresponding rows are applied, respectively, to the corresponding data lines Dⱼ. A low-level emission control signal emit2[i] is sequentially applied to the emission control signal line E₂₁ to E₂ₘ in synchronization with sequentially applying the low-level select signal select[i] to the select scan lines S₁ to Sₘ. A current corresponding to the applied data voltage is transmitted to the organic light emitting element OLED2 through the emitting transistor M32 in each pixel area to emit light. The low-level period of the emission control signal emit2[i] is the same as the period which corresponds to the subfield 2F. Therefore, in the subfield 2F, the pixel on which the organic light emitting element OLED2 is formed emits light in the two pixels which are adjacent in the row direction.

As described above, one field is divided into two subfields, and the subfields are sequentially driven in the organic light emitting display driving method according to the first exemplary embodiment. One organic light emitting element of two pixels of one pixel area in each subfield emits light, and the two organic light emitting elements sequentially emit light through two subfields to thus represent colors. In addition, the number of data lines and the number of pixel drivers can be reduced since the two pixels share the data line Dⱼ and the pixel driver. As a result, the number of integrated circuits for driving the data lines can be reduced, and the elements can be easily arranged in the pixel area.

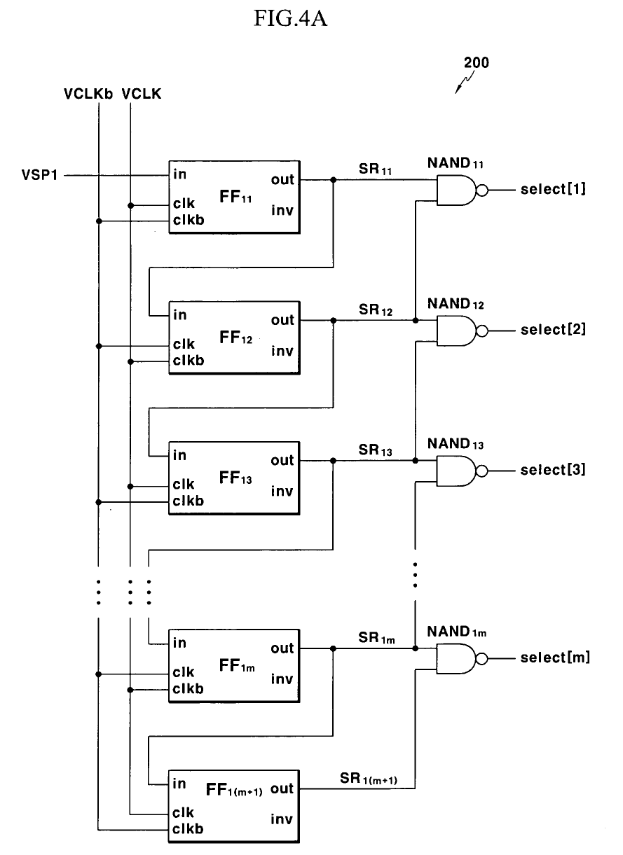

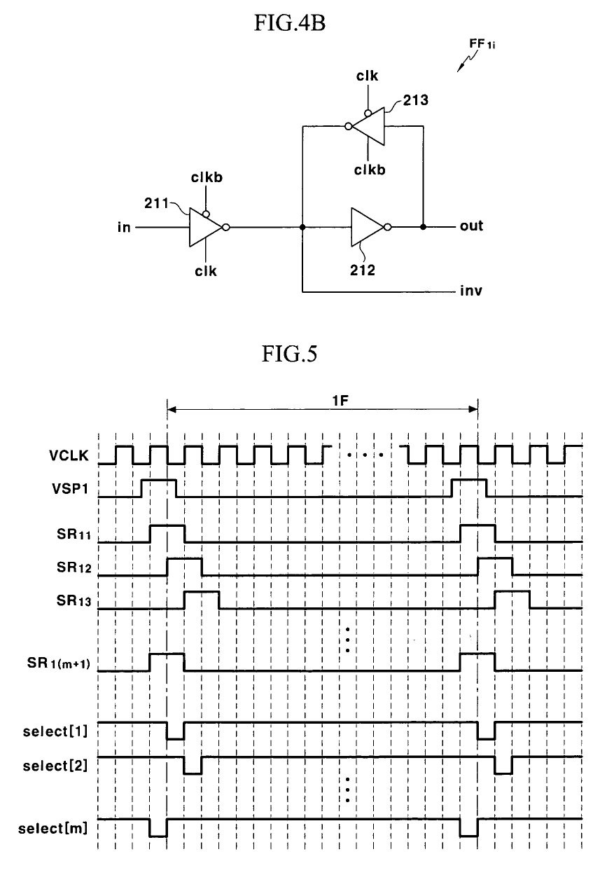

Next, the select scan driver 200 and the emit scan drivers 300, 400 for generating the waveforms shown in FIG. 3 will be described with reference to FIGS. 4A to 6.

FIG. 4A shows the select scan driver 200 in the organic light emitting display according to the first exemplary embodiment. FIG. 4B shows a flip-flop used in the select scan driver 200 of FIG. 4A. FIG. 5 shows a signal timing diagram in the select scan driver 200 of FIG. 4A. An inverted signal of a clock VCLK is depicted as VCLKb in FIG. 4A, which is not shown in FIG. 5. The low-level period of one clock VCLK cycle is the same as the high-level period of one clock VCLK cycle.

Since structures of the scan drivers 200, 300, 400 are determined by pulse widths and pulse levels of the outputted signals, the conditions of the outputted signals of the scan drivers 200, 300, 400 are assumed to be as follows. The low-level pulse width of the select signal select[i] is the same as the half clock VCLK cycle in order to minimize the frequency of the clock VCLK; the number m of the select scan lines S₁ to Sₘ is even, and the low-level pulse width of the emission control signal emit1[i] or emit2[i] corresponds to an integral multiple of ‘m’; and a flip-flop used in the scan drivers 200, 300, 400 outputs a signal which is input during a half clock cycle during a one clock VCLK cycle. In these conditions, since the output pulse of the flip-flop is an integral multiple of one clock VCLK cycle, the output signal of the flip-flop may not be used as a select signal.

Therefore, the select scan driver 200 includes (m+1) flip-flops FF₁₁ to FF₁₍ₘ₊₁₎ and m NAND gates NAND₁₁ to NAND₁ₘ as shown in FIG. 4A, and operates as a shift register. An output signal of the NAND gate NAND₁ᵢ is the select signal select[i] (where ‘i’ is a positive integer of less than ‘m’). The start signal VSP1 is input to the first flip-flop FF₁₁ in FIG. 4A, and the output signal SR₁ᵢ of the i^{th} flip-flop FF₁ᵢ is input to the (i+1)^{th} flip-flop FF₁₍ᵢ₊₁₎. The i^{th} NAND gate NAND₁ᵢ performs a NAND operation to the output signals SR₁ᵢ, SR₁₍ᵢ₊₁₎ of the two adjacent flip-flops FF₁ᵢ, FF₁₍ᵢ₊₁₎ and outputs the select signal select[i]. The clock VCLKb or VCLK inverted to the clock VCLK or VCLKb, which are used in the flip-flop FF₁ᵢ, are used in the flip-flops FF₁₍ᵢ₊₁₎ adjacent to the flip-flip FF₁ᵢ.

In more detail, the flip-flop FF₁ᵢ which is located at the odd-numbered position in the longitudinal direction uses the clocks VCLK, VCLKb as inner clocks clk, clkb, respectively, and the flip-flop FF₁ᵢ which is located at the even-numbered position in the longitudinal direction uses the clocks VCLKb, VCLK as inner clocks clk, clkb, respectively. In addition, the flip-flop FF₁ᵢ outputs an input signal in response to the high-level clock clk, and latches and outputs the input signal of the high-level clock clk in response to the low-level clock clk. As a result, the output signal SR₁₍ᵢ₊₁₎ of the flip-flop FF₁₍ᵢ₊₁₎ is shifted from the output signal SR₁ᵢ of the flip-flop FF₁ᵢ by the half clock VCLK cycle.

As shown in FIG. 5, since the start signal VSP1 has a high-level pulse in the high-level period of the one clock VCLK cycle in the respective subfields 1F, 2F, the flip-flop FF₁₁ outputs the high-level pulse during one clock VCLK cycle in the respective subfields 1F, 2F. As a result, the flip-flops FF₁₁ to FF₁ₘ may sequentially output each output signal SR₁ᵢ by shifting the high-level pulse by the half clock VCLK cycle.

The NAND gate NAND₁ᵢ performs the NAND operation of the output signals SR₁ᵢ, SR₁₍ᵢ₊₁₎ of the flip-flops FF₁ᵢ, FF₁₍ᵢ₊₁₎, and outputs a low-level pulse when both output signals SR₁₁, SR₁₍ᵢ₊₁₎ are high-level. Here, since the output signal SR₁₍ᵢ₊₁₎ of the flip-flop FF₁₍ᵢ₊₁₎ is shifted from the output signal SR₁ᵢ of the flip-flop FF₁ᵢ by the half clock VCLK cycle, the output signal of the NAND gate NAND₁ᵢ has a low-level pulse in a period, i.e., the half clock cycle during which the both output signals SR₁ᵢ, SR₁₍ᵢ₊₁₎ have the high-level pulse in common in the respective subfields 1F, 2F. In addition, the output signal select[i+1] of the NAND gate NAND₁₍ᵢ₊₁₎ is shifted from the output signal select[i] of the NAND gate NAND₁ᵢ by half the clock VCLK cycle. Therefore, the select scan driver 200 may sequentially output each select signal select[i] by shifting the low-level pulse by the half clock VCLK cycle.

Referring to FIG. 4B, the flip-flop FF₁ᵢ includes a clocked inverter 211, and an inverter 212 and a clocked inverter 213 for forming a latch. The clocked inverter 211 inverts an input signal (in) when the clock clk is high-level, and the inverter 212 inverts the output signal of the clocked inverter 211. When the clock clk is low-level, the output of the clocked inverter 211 is blocked, the output signal of the inverter 212 is input to the clocked inverter 213, and the output signal of the clocked inverter 213 is input to the inverter 212. As a result, the latch is formed. At this time, the output signal (out) of the inverter 212 is the output signal of the flip-flop FF₁ᵢ, and the input signal (inv) of the inverter 212 is the inverted signal to the output signal (out). Therefore, the flip-flop FF₁ᵢ can output the input signal (in) when the clock (clk) is high-level, and latch and output the input signal (in) in the high-level period of the clock (clk) when the clock (clk) is low-level.

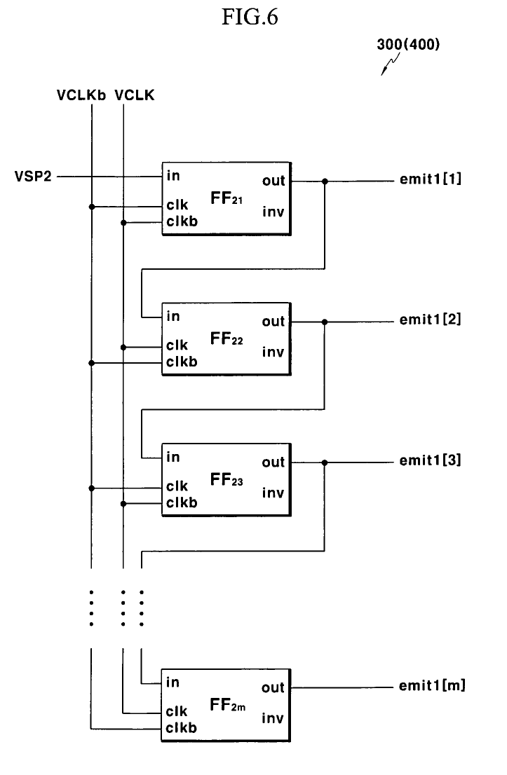

Next, the emit scan drivers 300, 400 for generating the waveforms of FIG. 3 will be described with reference to FIG. 6. FIG. 6 shows an emit scan driver 300 or 400 in the organic light emitting display according to the first exemplary embodiment.

Referring to FIG. 6, the emit scan driver 300 includes m flip-flops FF₂₁ to FF₂ₘ, and operates as a shift register. The emit scan driver 300 use a clock the same as the clock VCLK of the select scan driver 200. A start signal VSP2 is input to the first flip-flop FF₂₁, and the output signal of the i^{th} flip-flop FF₂ᵢ is the emission control signal emit1[i] of the i^{th} emission control signal line E₁ᵢ, and is input to the (i+1)^{th} flip-flop FF₂₍ᵢ₊₁₎.

The clock VCLKb or VCLK inverted to the clock VCLK or VCLKb, which is used in the flip-flop FF₂ᵢ, are used in the flip-flops FF₂₍ᵢ₊₁₎ adjacent to the flip-flop FF₂ᵢ. In addition, a falling edge of a low-level pulse in the emission control signal emit1[1] of the first flip-flop FF₂₁ is shifted from a rising edge of a high-level pulse in the output signal SR₁₁ of the first flip-flop FF₁₁. Therefore, differently from FIG. 4A, the flip-flop FF₂ᵢ which is located at the odd-numbered position in the longitudinal direction uses the clocks VCLKb, VCLK as inner clocks clk, clkb, respectively, and the flip-flop FF₂ᵢ which is located at the even-numbered position in the longitudinal direction uses the clocks VCLK, VCLKb as inner clocks clk, clkb, respectively. Here, the flip-flop FF₂ᵢ has the same structure as the flip-flop FF₁ᵢ described in FIGS. 4A and 4B.

Since the start signal VSP2 has a low-level pulse in the low-level period of all clock VCLK cycles in the subfield 1F, the output signal emit1[1] of the flip-flop FF₂₁ has a low-level pulse in the subfield 1F. In addition, since the start signal VSP2 has a high-level pulse in the low-level period of all clock VCLK cycles in the subfield 2F, the output signal emit1[1] of the flip-flop FF₂₁ has a high-level pulse in the subfield 2F.

Therefore, the emit scan driver 300 can sequentially output each emission control signal emit1[i], which has the low-level pulse in a period which corresponds to the subfield 1F, by shifting the half clock VCLK cycle. Here, if the low-level period is shorter than the period which corresponds to the subfield 1F, the low-level period becomes shorter than the period which corresponds to the subfield 1F.

Since the emission control signal emit2[i] which is an output signal of the emit scan driver 400 is inverted to the emission control signal emit1[i] of the emit scan driver 300, the emit scan driver 400 may have the same structure as the emit scan driver 300. Here, if the subfield 1F has the same period as the subfield 2F, a signal, which is shifted from the start signal VSP2 by the period corresponding to the subfield 1F, may be used as a start signal of the emit scan driver 400. Then, the emit scan driver can sequentially output the each emission control signal emit2[i] by shifting the half clock VCLK cycle as shown in FIG. 3.

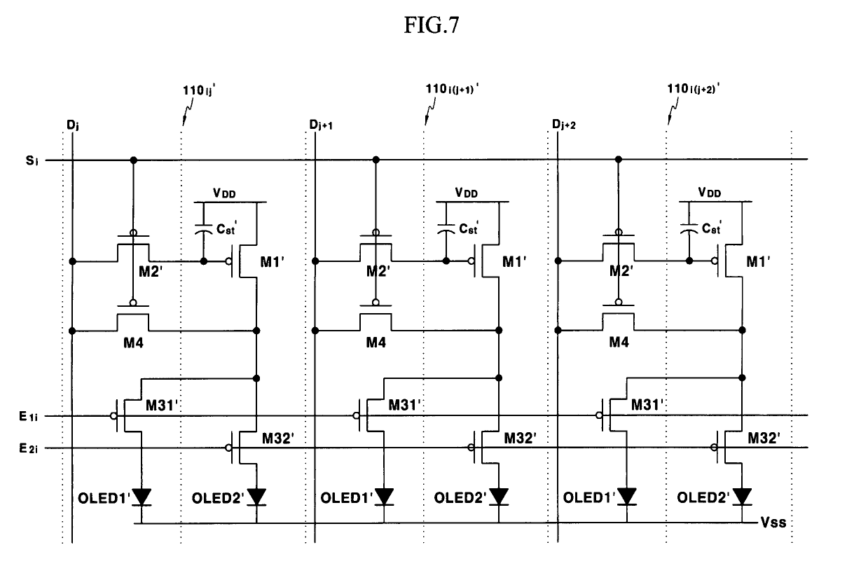

According to the select scan driver 200 and the emit scan drivers 300 and 400 as described above, the falling edge of the select signal select[i] in the respective subfields 1F, 2F corresponds to the falling edge of the respective emission control signals emit1[i], emit2[i] transmitted to the emission control signal lines E₁ᵢ, E₂ᵢ. The select signal select[i] and emission control signals emit1[i], emit2[i] may be used for the organic light emitting display using the voltage programming method. However, in the organic light emitting display using the current programming method, the current from the driving transistor M1 needs to be blocked from the organic light emitting elements OLED1, OLED2 when the corresponding data signal are programmed to the pixel. These exemplary embodiments will be described with reference to FIG. 7 to FIG. 12.

FIG. 7 shows a schematic diagram of the pixel areas of the organic light emitting display according to a second exemplary embodiment of the present invention. The organic light emitting display according to a second exemplary embodiment uses the current programming method in which the data signals converted to the analog currents (hereinafter, “data currents”) are applied to the data lines D₁ to Dₙ.

As shown in FIG. 7, the pixel areas 110′ᵢⱼ, 110′ᵢ₍ⱼ₊₁₎, 110′ᵢ₍ⱼ₊₂₎ according to the second exemplary embodiment have the same structure as that according to the first exemplary embodiment except for a pixel driver. In more detail, the pixel driver includes a driving transistor M1′, a switching transistor M2′, a diode-connecting transistor M4, and a capacitor Cst′. The connecting structure of the transistors M1′, M2′, M31′, M32′, the capacitor Cst′, the select scan line Sᵢ, the emit scan lines E₁ᵢ, E₂ᵢ, and the data line Dⱼ are the same as those described in FIG. 2. In addition, the transistor M4 is coupled between the drain of the transistor M1′ and the data line Dⱼ, and the gate of the transistor M4 is coupled to the select scan line Sᵢ.

The transistors M2′, M4 are turned on and the data current provided by the data line Dⱼ flows to the drain of the transistor M1′ in response to a low-level select signal provided by the select scan line Sᵢ. Then, the capacitor Cst′ is charged until a current flowing to the drain of the transistor M1′ by the voltage stored in the capacitor Cst′ corresponds to the data current. That is, the voltage corresponding to the data current is stored in the capacitor Cst′.

When the emit transistor M31′ is turned on in response to a low-level emission control signal emit1[i]′ provided by the emission control signal line E₁ᵢ, the current I_{OLED} which corresponds to the voltage stored in the capacitor Cst′ is transmitted to the organic light emitting element OLED1′ from the driving transistor M1′ to emit light. In a like manner, when the emitting transistor M32′ is turned on in response to a low-level emission control signal emit2[i]∝0 provided by the emission control signal line E₂ᵢ, the current which corresponds to the voltage stored in the capacitor Cst′ is transmitted to the organic light emitting element OLED2′ from the driving transistor M1′ to emit light.

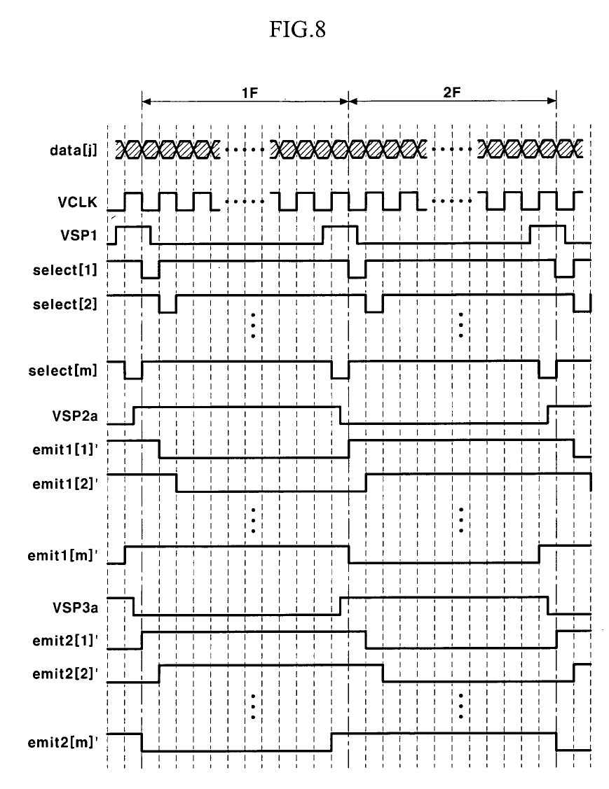

Next, a driving method of the organic light emitting display according to the second exemplary embodiment of the present invention will be described in more detail with reference to FIG. 8.

Referring to FIG. 8, one field is divided into the two subfields 1F, 2F, and the driving method according to the second exemplary embodiment is the same as that according to the first exemplary embodiment except for the timing of the emission control signals emit1[i]′, emit2[i]′.

In the subfield 1F, the emission control signal emit1[i]′ transmitted to the i^{th} emission control signal line E₁ᵢ has the low-level pulse after the select signal select[i] transmitted to the i^{th} select scan line Sᵢ rises to the high-level. In addition, the emission control signal emit1[i]′ has the low-level pulse during a period which corresponds to a difference between the subfield 1F and the low-level pulse width of the select signal select[i].

Then, when a low-level select signal select[i] is applied to the select scan line Sᵢ, the data current data[j]′ corresponding to the organic light emitting element OLED1 of each pixel area on the i^{th} row are applied to the corresponding data lines Dⱼ. At this time, since the high-level emission control signals emit1[i]′, emit2[i]′ are applied to the emission control signal lines E₁ᵢ, E₂ᵢ on the i^{th} row, the organic light emitting elements OLED1′, OLED2′ are electrically interrupted from the driving transistor M1′. Therefore, the voltage corresponding to the data current data[j]′ is stored in the capacitor Cst′. Next, a low-level emission control signal emit1[i]′ is applied to the emission control signal line E₁ᵢ on the first row. The emit transistor M31′ of the pixel area on the i^{th} row is turned on, and a current corresponding to the voltage stored in the capacitor Cst′ is transmitted to the organic light emitting element OLED1 to thus emit light.

In a like manner, the low-level select signals select[1] to select[m] are sequentially applied to the select scan lines S₁ to Sₘ of from the first to the m^{th} rows. When the select signal select[i] of the select scan line Sᵢ rises to the high-level, the low-level emission control signal emit1[i]′ is applied to the emit scan line E₁ᵢ on the i^{th} row.

In the subfield 2F, in a like manner as the subfield 1F, the emission control signal emit2[i]′ transmitted to the i^{th} emission control signal line E₂ᵢ has the low-level pulse after the select signal select[i] transmitted to the i^{th} select scan line Sᵢ rises to the high-level. In addition, the emission control signal emit1[i]′ has the low-level pulse during a period which corresponds to a difference between the subfield 2F and the low-level pulse width of the select signal select[i].

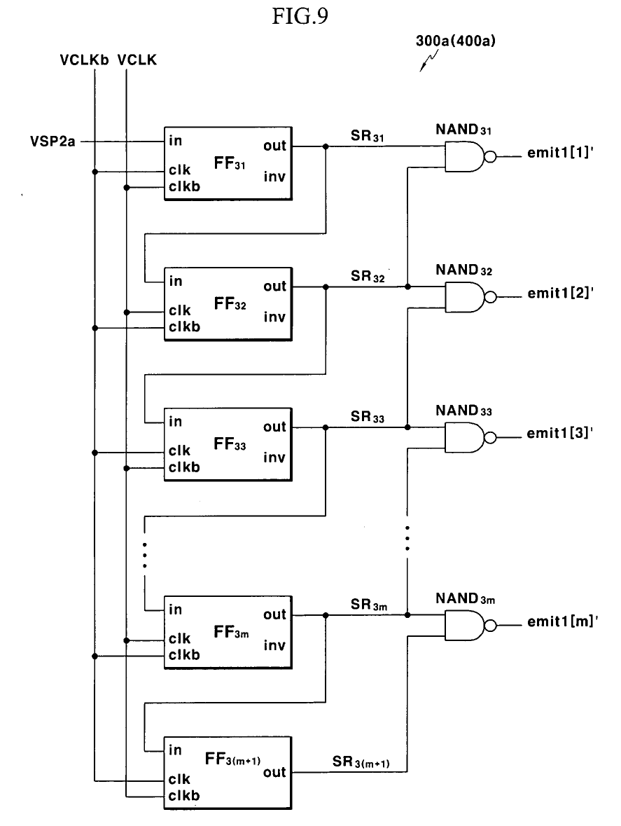

Next, emit scan drivers 300a, 400a for generating the waveforms shown in FIG. 8 will be described with reference to FIGS. 9 to 12.

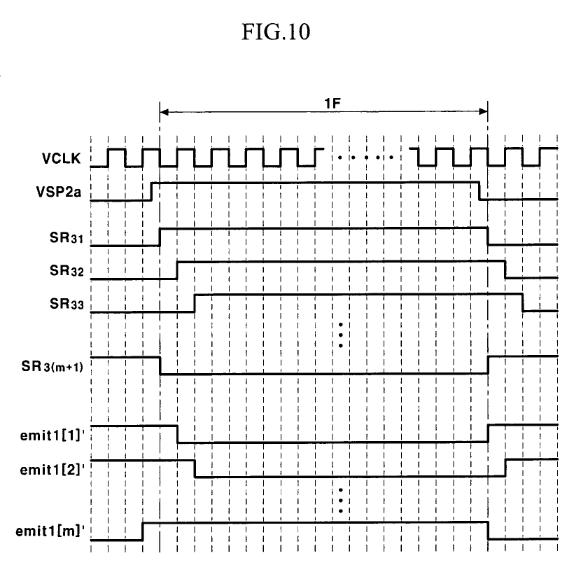

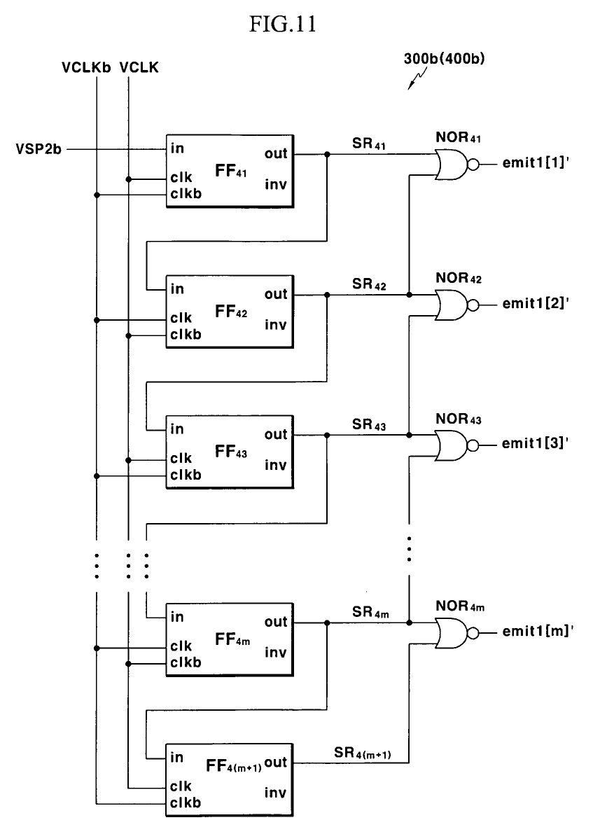

FIG. 9 shows the emit scan driver 300a in the organic light emitting display according to the second exemplary embodiment, and FIG. 10 shows a signal timing diagram of the emit scan driver 300a shown in FIG. 9. As shown in FIGS. 3 and 8, since the timing of the select signal select[i] in the organic light emitting display according to the second exemplary embodiment is the same as that according to the first exemplary embodiment, the select scan driver 200 shown in FIGS. 4A and 4B may be used as the select scan driver according to the second exemplary embodiment.

In the second exemplary embodiment, since the emission control signal emit1[i]′ is the high-level when the select signal select[i] is the low-level, the low-level pulse width of the emission control signal emit1[i]′ becomes an odd multiple of the half clock cycle. However, since the output signal of the emit scan driver 300 shown in FIG. 6 is an integral multiple of the one clock cycle, the emit scan driver 300 shown in FIG. 6 may not be applicable to the signal timing diagram shown in FIG. 8.

Therefore, as shown in FIG. 9, the emit scan driver 300a according to the second exemplary embodiment includes (m+1) flip-flops FF₃₁ to FF₃₍ₘ₊₁₎ and m NAND gates NAND₃₁ to NAND₃ₘ, and operates as a shift register. A start pulse VSP2a shown in FIGS. 8 and 10 is input to first flip-flop FF₃₁, and an output signal SR₃ᵢ of i^{th} the flip-flop FF₃ᵢ is input to the (i+1)^{th} flip-flop FF₃₍ᵢ₊₁₎ (where ‘i’ is an positive integer less that ‘m’). The NAND gate NAND₃ᵢ performs NAND operation between the output signals SR₃ᵢ, SR₃₍ᵢ₊₁₎ of the two flip-flops FF₃ᵢ, FF₃₍ᵢ₊₁₎, and outputs the emission control signal emit1[i]′.

Here, the emit scan driver 300a has the same structure as that shown in FIG. 4A except for the clocks VCLK, VCLKb. That is, the flip-flop FF₃ᵢ which is located at the odd number of position in the longitudinal direction uses the clocks VCLKb, VCLK as inner clocks clk, clkb, respectively, and the flip-flop FF₃ᵢ which is located at the even number of position uses the clocks VCLK, VCLKb as inner clocks clk, clkb, respectively. Then, the falling edge of the low-level pulse in the emission control signal emit1[i]′ can be shifted by the half clock VCLK cycle from the falling edge of the low-level pulse in the select signal select[i].

The first flip-flop FF₃₁ receives the start signal VSP2a when the clock VCLK is the low-level, and outputs the received signal during the one clock VCLK cycle. Referring to FIG. 10, the start signal VSP2a has the high-level pulse in the low-level period of all clock VCLK cycles in the subfield 1F, and has the low-level pulse in the low-level period of all clock VCLK cycles in the subfield 2F. Therefore, the flip-flops FF₃₁ to FF₃₍ₘ₊₁₎ may sequentially output the output signals, which respectively have the high-level pulses in a period which corresponds to the subfield 1F, by shifting the half clock VCLK cycle.

The NAND gate NAND₃ᵢ performs NAND operation between the output signals SR₃ᵢ, SR₃₍ᵢ₊₁₎ of the flip-flops FF₃ᵢ, FF₃₍ᵢ₊₁₎, and outputs the low-level pulse while the both output signals SR₃ᵢ, SR₃₍ᵢ₊₁₎ are the high-level. Therefore, the output signal of the NAND gate NAND₃ᵢ, i.e. the emission control signal emit1[i]′ has the low-level pulse during a period which corresponds to a difference the subfield 1F and the half clock VCLK cycle. The falling edge of the emission control signal emit1[i]′ corresponds to the rising edge of the select signal select[i]. In addition, as shown in FIGS. 4A and 5, the emission control signal emit1[i+1]′ which is the output signal of the NAND gate NAND₃₍ᵢ₊₁₎ is shifted by the half clock VCLK cycle from the emission control signal emit1[i]′ which is the output signal of the NAND gate NAND₃ᵢ.

Since the emission control signal emit2[i]′ in the subfield 2F has the waveform shifted from the emission control signal emit1[i]′, the emit scan driver 300a may be applicable to the emit scan driver 400a. Here, if the period corresponding to the subfield 1F is the same as the period corresponding to the subfield 2F, a signal shifted by the subfield 1F from the start signal VSP2a can be used as a start signal VSP3a of the emit scan driver 400a.

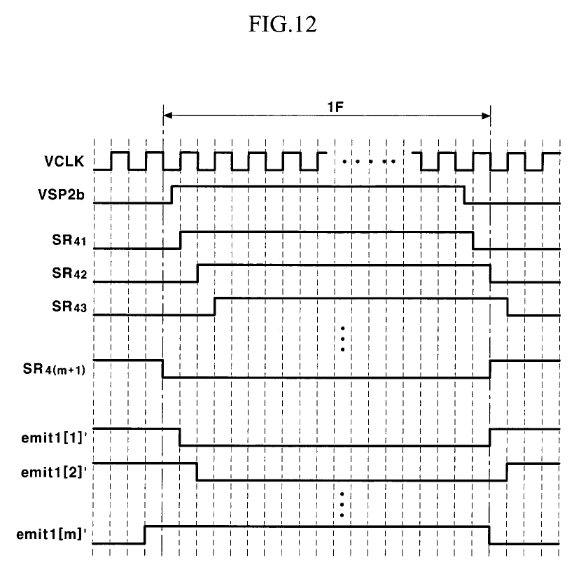

As described above, the emit scan drivers 300a, 400a have the same structure as the select scan driver 200 shown in FIGS. 4A and 4B, but further embodiments may have a different structure from that of select scan driver 200. These further embodiments will be described in more detail with reference to FIGS. 11 and 12.

FIG. 11 shows an emit scan driver 300b in an organic light emitting display according to a third exemplary embodiment, and FIG. 12 shows a signal timing diagram of the emit scan driver 300b shown in FIG. 11.

As shown in FIG. 11, the emit scan driver 300b according to the third exemplary embodiment includes (m+1) flip-flops FF₄₁ to FF₄₍ₘ₊₁₎ and m NOR gates NOR₄₁ to NOR₄ₘ, and operates as a shift register. An output signal of the NOR gate NOR₄₁ is the emission control signal emit[1]′ transmitted to the emit scan line E₁ᵢ. A start pulse VSP2b shown in FIG. 12 is input to first flip-flop FF₄₁, and an output signal SR₄ᵢ of i^{th} the flip-flop FF₄ᵢ is input to the (i+1)^{th} flip-flop FF₄₍ᵢ₊₁₎ (where ‘i’ is an positive integer less that ‘m’). The NOR gate NOR₄ᵢ performs a NOR operation between the output signals SR₄ᵢ, SR₄₍ᵢ₊₁₎ of the two flip-flops FF₄ᵢ, FF₄₍ᵢ₊₁₎, and outputs the emission control signal emit1[i]′.

In the third embodiment, the emission control signal emit1[i]′ is generated by a NOR operation. For the NOR operation, the output signal SR₄ᵢ of the flip-flop FF₄ᵢ is shifted by the half clock VCLK cycle from the output signal SR₃ᵢ of the flip-flop FF₃ᵢ. Therefore, the flip-flop FF₄ᵢ uses the clock VCLK or VCLKb inverted to the clock VCLKb or VCLK of the flip-flop FF₃ᵢ shown in FIG. 9, and the first flip-flop FF₄₁ receives the start signal VSP2b when the clock VCLK is the high-level and outputs the received signal during the one clock VCLK cycle. As shown in FIG. 12, since the start pulse VSP2b has the high-level pulse in the high-level period of all clock VCLK cycles during a period which corresponds to a difference between the subfield 1F and the one clock VCLK cycle, the output signal SR₄₁ of the flip-flop FF₄₁ has the high-level pulse during this period. In addition, since the start signal VSP2b is the low-level in the subfield 2F, the output signal SR₄₁ is the low-level in the subfield 2F. Accordingly, the flip-flops FF₄₁ to FF₄₍ₘ₊₁₎ may sequentially output the output signals SR₄₁ to SR₄₍ₘ₊₁₎ by shifting the high-level pulse by the half clock VCLK cycle, and the respective output signals SR₄₁ to SR₄₍ₘ₊₁₎ have the high-level pulse in the period which corresponds to the difference between the subfield 1F and the one clock VCLK cycle.

NOR gate NOR₄ᵢ outputs the low-level pulse while at least one of the output signals SR₄ᵢ, SR₄₍ᵢ₊₁₎ of the flip-flops FF₄ᵢ, FF₄₍ᵢ₊₁₎ is the high-level. Therefore, the output signal emit1[i]′ has the low-level pulse in a period which corresponds to a difference between the subfield and the half clock VCLK cycle, and the falling edge of the low-level pulse corresponds to the rising edge of the select signal select[i]. In addition, the output signal emit1[i+1]′ is shifted from the emission control signal emit1[i]′ by the half clock VCLK cycle since the output signal SR₄₍ᵢ₊₁₎ is shifted from the output signal SR₄ᵢ by the half clock VCLK cycle.

Since the emission control signal emit2[i]′ in the subfield 2F has the waveform shifted from the emission control signal emit1[i]′, the emit scan driver 300b may be applicable to the emit scan driver 400b. Here, if the period corresponding to the subfield 1F is the same as the period corresponding to the subfield 2F, a signal shifted by the subfield 1F from the start signal VSP2b can be used as a start signal of the emit scan driver 400b.

As described above, the emit scan driver used in the organic light emitting display of the current programming method may be applicable to that of the voltage programming method. That is, the emit scan driver according to the second and third exemplary embodiments may be applicable to the organic light emitting display in which the organic light emitting elements doesn't emit light in the low-level period of the select signal.

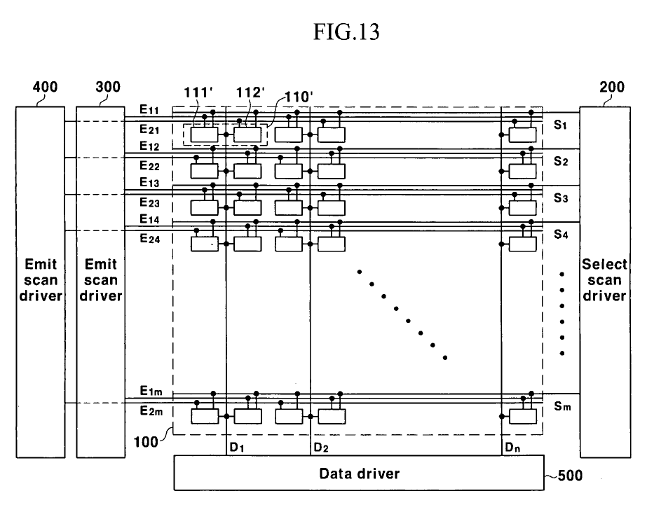

In addition, the select and emit scan drivers according to the first to third exemplary embodiment may be applicable to an organic light emitting display shown in FIG. 13. FIG. 13 shows a plan view of the organic light emitting display according to a fourth exemplary embodiment of the present invention.

Referring to FIG. 13, a connection between the emit scan lines E₁ᵢ, E₂ᵢ on the i^{th} row and the pixel area 110′ is different from a connection between the emit scan lines E₁₍ᵢ₊₁₎, E₂₍ᵢ₊₁₎ on the (i+1)^{th} row and the pixel area 110′. In more detail, if the emit scan line E₁ᵢ is coupled to the left pixels 111′ of the pixel areas 110′ on the i^{th} row (where ‘i’ is an odd integer less than ‘m’) and the emit scan line E₂ᵢ is coupled to the right pixels 112′ of the pixel areas 110′ on the i^{th} row, the emit scan line E₁₍ᵢ₊₁₎ is coupled to the right pixels 112′ of the pixel areas 110′ on the (i+1)^{th} row and the emit scan line E₂₍ᵢ₊₁₎ is coupled to the left pixels 112′ of the pixel areas 110′ on the (i+1)^{th} row. Then, the left pixels 111′ of the pixel areas 110′ on the odd row and the right pixels 112′ of the pixel areas 110′ on the even row emit light in the subfield 1F, and the right pixels 112′ of the pixel areas 110′ on the odd row and the left pixels 111′ of the pixel areas 110′ on the even row emit light in the subfield 2F.

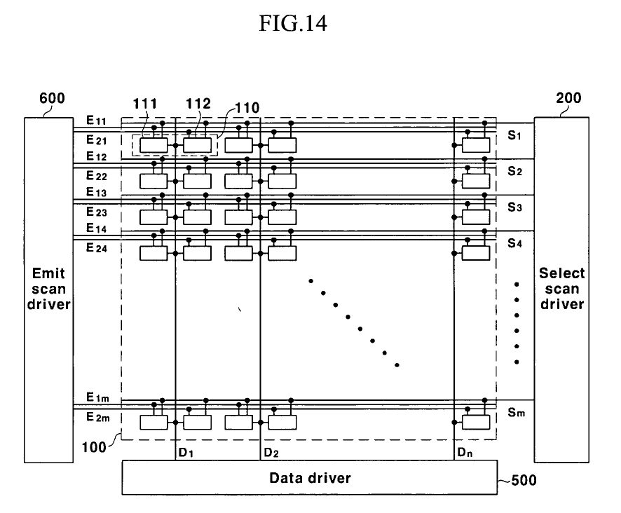

Next, exemplary embodiments which form the emit scan drivers 300, 400 as one emit scan driver will be described with reference to FIGS. 14 to 21.

FIG. 14 shows a plan view of an organic light emitting display according to a fifth exemplary embodiment of the present invention. The organic light emitting display according to the fifth exemplary embodiment has the same structure as that shown in FIG. 1 except for an emit scan driver 600 in place of emit scan drivers 300, 400. The emit scan driver 600 sequentially transmits emission control signals emit1[1] to emit1[m] for controlling light emission of pixels 111 to the emit scan lines E₁₁ to E₁ₘ in the subfield 1F, and sequentially transmits emission control signals emit2[1] to emit2[m] for controlling light emission of pixels 112 to the emit scan lines E₂₁ to E₂ₘ in the subfield 2F.

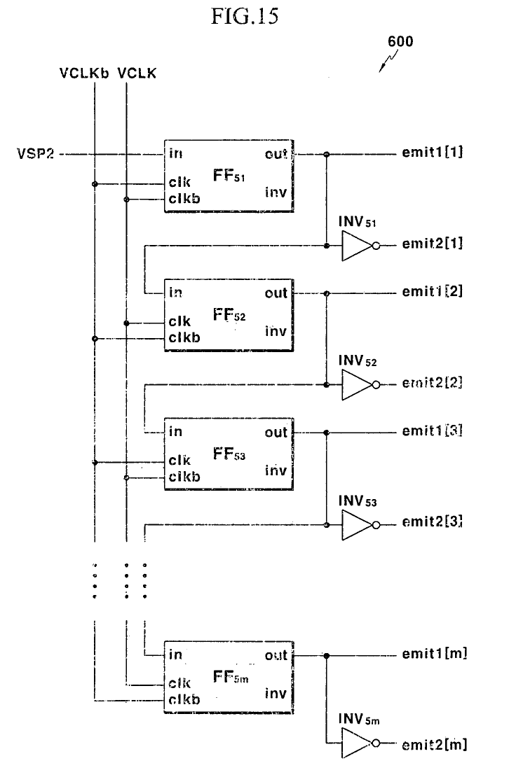

The emit scan driver 600 for generating the signal timing shown in FIG. 3 will be described with reference to FIG. 15.

As shown in FIG. 3, since the emission control signal emit2[i] is inverted to the emission control signal emit1[i], the emit scan driver 600 may output one, for example emit1[i], of the emission control signals emit1[i], emit2[i] as does the emit scan driver 300 shown in FIG. 6, and invert the emission control signal emit1[i] to output the emission control signal emit2[i].

Referring to FIG. 15, the emit scan driver 600 according to the fifth exemplary embodiment includes m flip-flops FF₅₁ to FF₅ₘ and m inverters INV₅₁ to INV₅ₘ, and operates as a shift register. The clock VCLK shown in FIG. 3 is input to the emit scan driver 600. The flip-flop FF₅ᵢ has the same connection and structure as the flip-flop FF₂ᵢ shown in FIG. 6. The start signal VSP2 shown in FIG. 3 is input to the flip-flop FF₅ᵢ.

An output signal of the i^{th} flip-flop FF₅ᵢ becomes the emission control signal emit1[i] of the emission control signal line E₁ᵢ on the i^{th} row, an input signal of the (i+1)^{th} flip-flop FF₅₍ᵢ₊₁₎, and an input signal of the i^{th} inverter INV₅ᵢ. An output signal of the i^{th} inverter INV₅ᵢ is the emission control signal emit2[i] of the emission control signal line E₂ᵢ on the i^{th} row, and the emission control signal emit2[i] is inverted to the emission control signal emit1[i] by the inverter INV₅ᵢ.

Accordingly, the emit scan driver 600 can sequentially output the emission control signals emit1[1] to emit1[m], which respectively have the low-level pulses in a period which corresponds to the subfield 1F, by shifting the half clock VCLK cycle. The emit scan driver 600 inverts the emission control signals emit1[1] to emit1[m] to thus sequentially output the emission control signals emit2[1] to emit2[m], which respectively have the low-level pulses in a period which corresponds to the subfield 2F, by shifting the half clock VCLK cycle.

Referring FIG. 4B, since the input signal of the inverter 212 is inverted to the output signal (out), the input signal of the inverter 212 can be an inverted output signal (inv) of the flip-flop. Therefore, the inverted output signal (inv) can be used as the emission control signal emit2[i], and the inverter INV₅ᵢ can be eliminated in the emit scan driver 600.

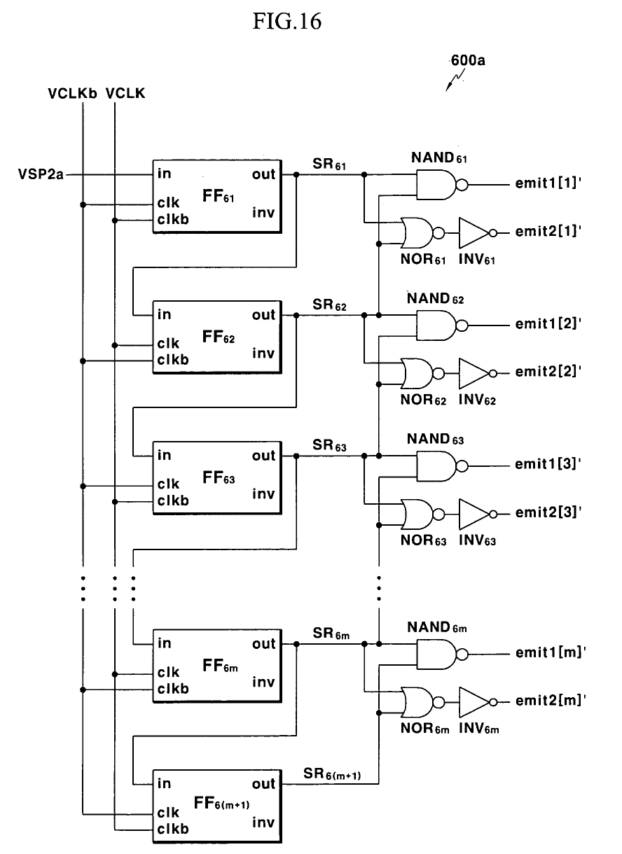

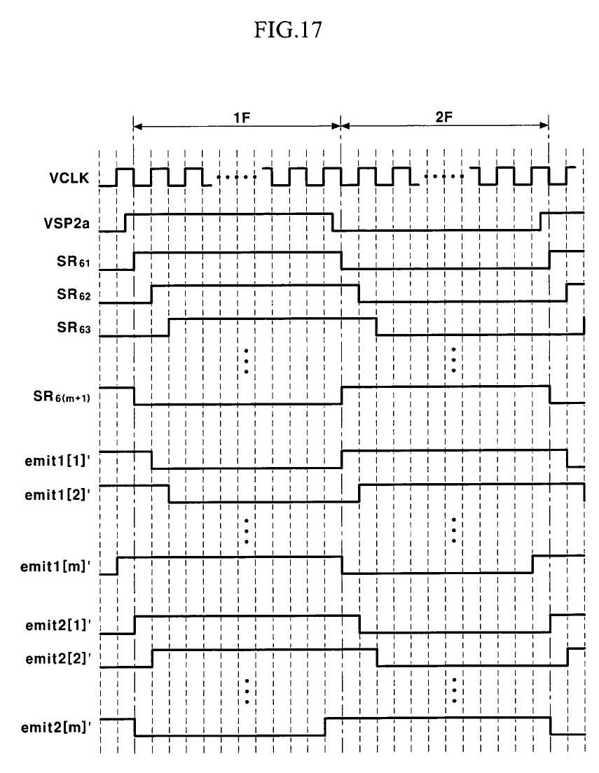

An emit scan driver 600a for generating the signal timing shown in FIG. 8 will be described with reference to FIGS. 16 and 17. FIG. 16 shows the emit scan driver 600a in an organic light emitting display according to a sixth exemplary embodiment, and FIG. 17 shows a signal timing diagram of the emit scan driver 600a shown in FIG. 16.

The emit scan driver 600a may generate one, for example, emit1[i]′ of the emission control signals emit1[i]′, emit2[i]′ as does the emit scan driver 300a shown in FIG. 9, and may generate the emission control signal emit2[i] from the emission control signal emit1[i].

Referring FIG. 16, the emit scan driver 600a according to the sixth exemplary embodiment includes (m+1) flip-flops FF₆₁ to FF₆₍ₘ₊₁₎, m NAND gates NAND₆₁ to NAND₆ₘ, m NOR gates NOR₆₁ to NOR₆ₘ, and m inverters INV₆₁ to INV₆ₘ, and operates as a shift register. The clock VCLK shown in FIG. 3 is input to the emit scan driver 600. An output signal of the i^{th} NAND gate NAND₆ᵢ is the emission control signal emit1[i]′ of the emission control signal line E₁ᵢ on the i^{th} row, and a signal which is inverted to an output signal NOR gate NOR₆ᵢ by the inverter INV₆ᵢ is the emission control signal emit2[i]′ of the emission control signal line E₂ᵢ on the i^{th} row.

The flip-flop FF₅ᵢ and the NAND gate NAND₆ᵢ have the same connection and structure as the flip-flop FF₂ᵢ and the NAND gate NAND₂ᵢ shown in FIG. 9. The start signal VSP2a shown in FIGS. 8 and 17 is input to the flip-flop FF₆₁. Then, as shown in FIG. 9, the NAND gates NAND₆₁ to NAND₆ₘ can sequentially output the emission control signals emit1[i]′ to emit1[m]′, which respectively have the low-level pulses in a period which corresponds to a difference between the subfield 1F and the half clock VCLK cycle, by shifting the half clock VCLK cycle.

The NOR gate NOR₆ᵢ performs a NOR operation between the output signal SR₆ᵢ, SR₆₍ᵢ₊₁₎ of the flip-flops FF₆ᵢ, FF₆₍ᵢ₊₁₎ to output an output signal to the inverter INV₆ᵢ. Here, the NOR gate NOR₆ᵢ and the inverter INV₆ᵢ operate as an OR gate.

Referring to FIG. 17, the output signal SR₆ᵢ of the flip-flops FF₆ᵢ has the low-level pulse in a period which corresponds to the subfield 2F, and the NOR gate NOR₆ᵢ outputs the high-level pulse while both the output signal SR₆ᵢ, SR₆₍₊₁₎ of the flip-flops FF₆ᵢ, FF₆₍ᵢ₊₁₎ are the low level. Accordingly, the output signal of the NOR gate NOR₆ᵢ has the high-level pulse in a period which corresponds to a difference between the subfield 2F and the half clock VCLK cycle, and the inverter INV₆ᵢ inverts the output signal of the NOR gate NOR₆ᵢ to output the emission control signal emit2[i]′. In addition, since the output signal of the NOR gate NOR₆₍ᵢ₊₁₎ is shifted from the output signal of the NOR gate NOR₆ᵢ by the half clock VCLK cycle, the emission control signals emit2[1]′ to emit2[m]′ can be sequentially output by being shifted by the half clock VCLK cycle.

In the sixth exemplary embodiment, the emission control signals emit1[i]′, emit2[i]′ are generated by a NAND operation and a NOR operation, respectively, but the emission control signal emit2[i]′ may be generated by a NAND operation.

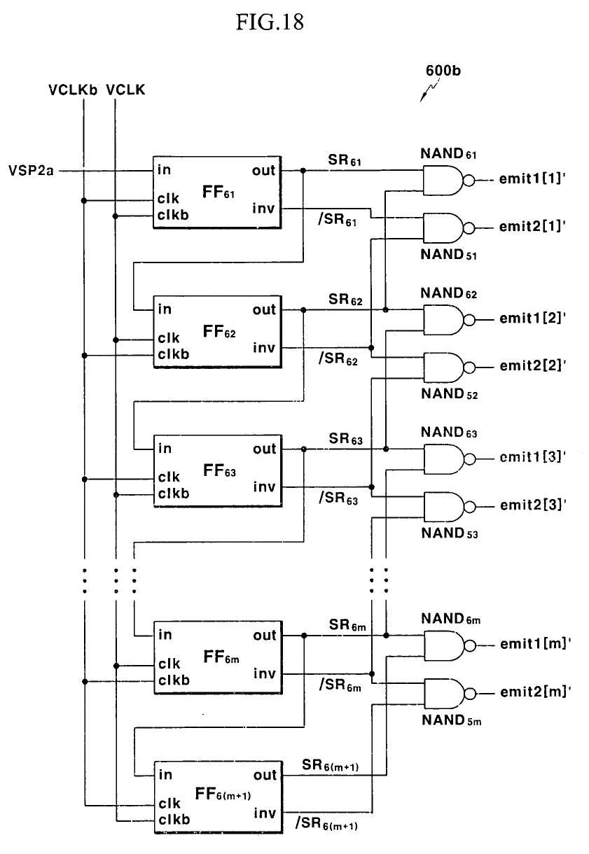

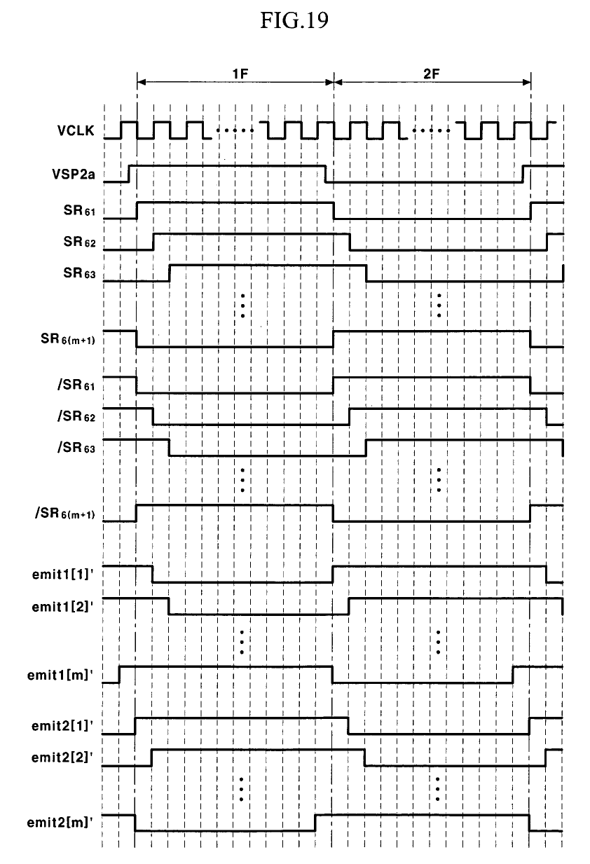

Referring to FIGS. 8 and 17, the emission control signal emit2[i]′ in the subfield 2F has the waveform shifted from the emission control signal emit1[i]′, and the output signal SR₆ᵢ of the flip-flop FF₆ᵢ in the subfield 2F has the waveform inverted to the waveform of the output signal SR₆ᵢ in the subfield 1F. Therefore, the emission control signal emit2[i]′ can be generated from a NAND operation of a signal inverted to the output signal SR₆ᵢ. This exemplary embodiment will be described with reference to FIGS. 18 and 19.

FIG. 18 shows an emit scan driver 600b in an organic light emitting display according to a seventh exemplary embodiment, and FIG. 19 shows a signal timing diagram of the emit scan driver 600b shown in FIG. 18.

Referring to FIG. 18, the emit scan driver 600b according to the seventh exemplary embodiment has the same structure as the emit scan driver 600a shown in FIG. 16 except for the NAND gate NAND₅ᵢ. In more detail, the emit scan driver 600b includes the flip-flops FF₆₁ to FF₆₍ₘ₊₁₎ and the NAND gates NAND₆₁ to NAND₆ₘ shown in FIG. 16, and includes m NAND gates NAND₅₁ to NAND₅ₘ instead of the NOR gates NOR₆₁ to NOR₆ₘ and the inverters INV₆₁ to INV₆ₘ.

As shown in FIG. 4B, since the input signal (inv) of the inverter 212 is inverted to the output signal of the flip-flop FF₆ᵢ, the input signal (inv) becomes an inverted output signal /SR₆ᵢ of the flip-flop FF₆ᵢ. The NAND gate NAND₅ᵢ performs a NAND operation between the inverted output signals /SR₆ᵢ, /SR₆₍ᵢ₊₁₎ of the flip-flops FF₆ᵢ, FF₆₍ᵢ₊₁₎ to output the emission control signal emit2[i]′.

Referring to FIG. 19, since the waveform of the inverted output signal /SR₆ᵢ in the subfield 2F is the same as the waveform of the output signal SR₆ᵢ in the subfield 1F, the emission control signal emit2[i]′ which is the output signal of the NAND gate NAND₅ᵢ has the signal timing shown in FIGS. 8 and 19.

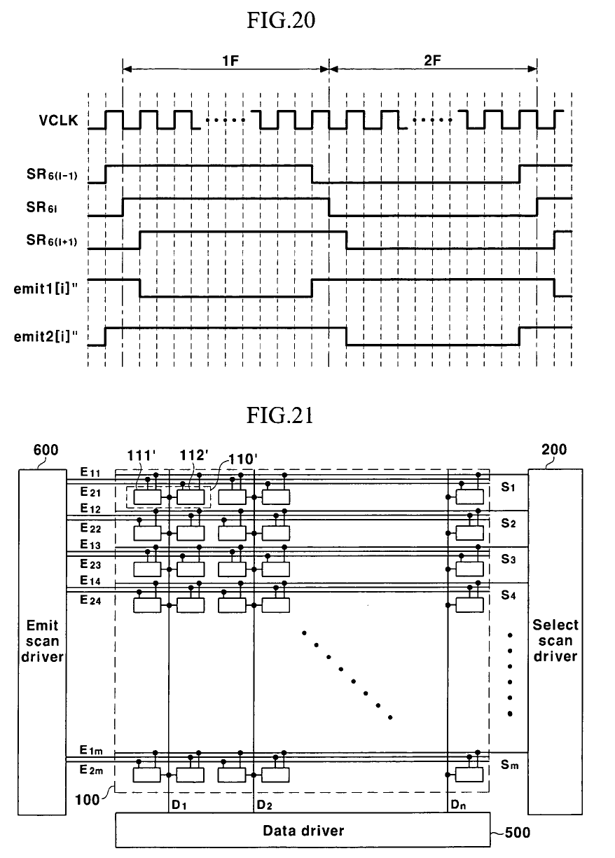

In the sixth and seventh exemplary embodiments, the emission control signal emit1[i]′ has the low-level pulse in the period which corresponds to the difference between the subfield 1F and the half clock VCLK cycle. Here, the low-level period of the emission control signal emit1[i]′ can be controlled by changing the input signals of the NAND gate and/or NOR gate as shown in FIG. 20.

Referring to FIG. 20, the output signals SR₆₍ᵢ₋₁₎, SR₆₍ᵢ₊₁₎ of the (i−1)^{th} and (i+1)^{th} flip-flops FF₆₍ᵢ₋₁₎, FF₆₍ᵢ₊₁₎ are input to the i^{th} NAND gate NAND₆ᵢ and the i^{th} NOR gate NOR₆ᵢ shown in FIG. 16. The emission control signal emit1[i]″ has the low-level pulse in a period which corresponds to a difference between the subfield 1F and the one clock VCLK cycle, and the emission control signal emit2[i]″ has the low-level pulse in a period which corresponds to a difference between the subfield 2F and the one clock VCLK cycle.

As shown FIG. 21, the select scan driver 200 and the emit scan driver 600, 600a, or 600b may be applicable to the organic light emitting display shown in FIG. 13. FIG. 21 shows a plan view of the organic light emitting display according to an eighth exemplary embodiment of the present invention.

Referring to FIG. 21, as shown in FIG. 13, the emit scan line E₁ᵢ is coupled to the left pixels 111′ of the pixel areas 110′ on the iₜₕ row (where ‘i’ is an odd integer of less than ‘m’) and the emit scan line E₂ᵢ is coupled to the right pixels 112′ of the pixel areas 110′ on the i^{th} row, and the emit scan line E₁₍ᵢ₊₁₎ is coupled to the right pixels 112′ of the pixel areas 110′ on the (i+1)^{th} row and the emit scan line E₂₍ᵢ₊₁₎ is coupled to the left pixels 112′ of the pixel areas 110′ on the (i+1)^{th} row. In addition, the emit scan lines E₁ᵢ, E₂ᵢ, E₁₍ᵢ₊₁₎, E₂₍ᵢ₊₁₎ are coupled to the emit scan driver 600.

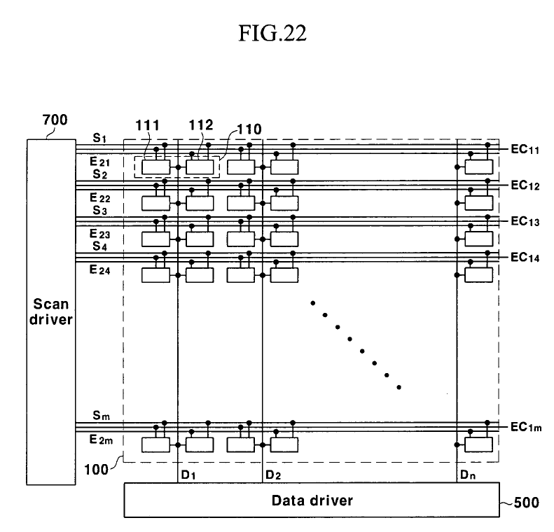

Next, exemplary embodiments which form the emit scan driver and the select scan driver as a unit scan driver 700 will be described with reference to FIGS. 22 to 33.

FIG. 22 shows a plan view of the organic light emitting display according to a ninth exemplary embodiment of the present invention. The organic light emitting display according to the ninth exemplary embodiment has the same structure as that shown in FIGS. 1 and 14 except for a scan driver 700 sharing the select scan driver and the emit scan driver. The scan driver 700 sequentially transmits select signals select[1] to select[m] for selecting corresponding lines to the select scan lines S₁ to Sₘ in the subfields 1F and 2F. In addition, the scan driver 700 sequentially transmits emission control signals emit1[1] to emit1[m] for controlling light emission of pixels 111 to the emit scan lines E₁₁ to E₁ₘ in the subfield 1F, and sequentially transmits emission control signals emit2[1] to emit2[m] for controlling light emission of pixels 112 to the emit scan lines E₂₁ to E₂ₘ in the subfield 2F.

As described in the fifth and eighth exemplary embodiments, the scan driver can generate both emission control signals emit1[i], emit2[i]. Therefore, the method for generating the select signal select[i] from this scan driver will be described below.

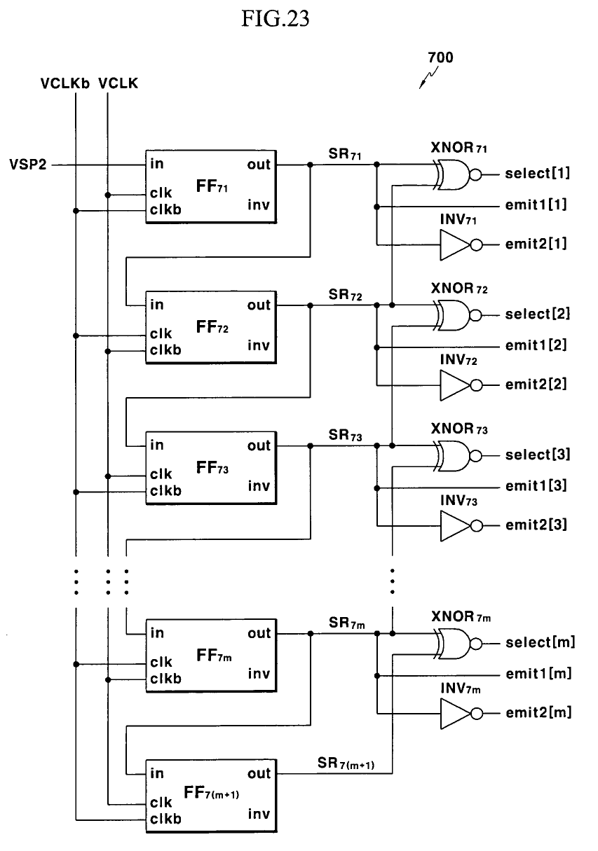

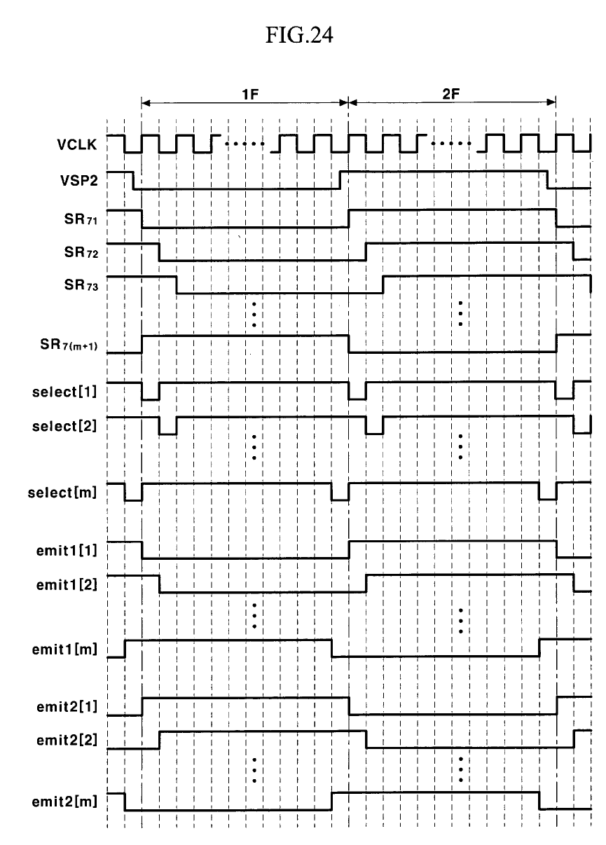

First, the scan driver 700 for generating the signal timing shown in FIG. 3 will be described with reference to FIGS. 23 and 24. FIG. 23 shows the scan driver 700 in the organic light emitting display according to the ninth exemplary embodiment, and FIG. 24 shows a signal timing diagram of the scan driver 700 shown in FIG. 23.

Referring to FIG. 3, the emission control signal emit2[i] is inverted to the emission control signal emit1[i], and the select signal select[i] has the low level in a period in which the level of the emission control signal emit1[i] is different from that of the emission control signal emit1[i+1]. Therefore, the scan driver 700 can generate the select signal [i] and the emission control signals emit1[i], emit2[i].

As shown in FIG. 23, the scan driver 700 includes (m+1) flip-flops FF₇₁ to FF₇₍ₘ₊₁₎, m XNOR gate XNOR₇₁ to XNOR₇ₘ, and m inverters INV₇₁ to INV₇ₘ, and operates as a shift register. Here, an XOR gate and an inverter may be used as the XNOR gate. In addition, the clock VCLK and the start signal VSP2 shown in FIG. 15 are input to the scan driver 700.

The flip-flop FF₅ᵢ and the inverter INV₇ᵢ have the same connection and structure as the flip-flop FF₅ᵢ and the inverter INV₅ᵢ shown in FIG. 15. Therefore, an output signal SR₇ᵢ of the flip-flop FF₇ᵢ is the emission control signal emit1[i], and a signal which is inverted to the output signal SR₇ᵢ of the flip-flop FF₇ᵢ by the inverter INV₇ᵢ is the emission control signal emit2[i].

The XNOR gate XNOR₇ᵢ performs XNOR operation between the output signals SR₇ᵢ, SR₇₍ᵢ₊₁₎ of the flip-flops FF₇ᵢ, FF₇₍ᵢ₊₁₎ to output the select signal select[i]. That is, the XNOR gate XNOR₇ᵢ outputs the low-level select signal select[i] while the output signals SR₇ᵢ, SR₇₍ᵢ₊₁₎ of the flip-flops FF₇ᵢ, FF₇₍ᵢ₊₁₎ have the different levels.

Referring to FIG. 24, the output signal SR₇₍ᵢ₊₁₎ of the flip-flop FF₇₍ᵢ₊₁₎ is shifted from the output signal SR₇ᵢ of the flip-flop FF₇ᵢ by the half clock VCLK cycle. Therefore, the output signal select[i] of the XNOR gate XNOR₇ᵢ has the low-level pulse during the half clock VCLK cycle in the respective subfields 1F, 2F. The falling edges of the low-level pulses in the select signal select[i] respectively correspond to the falling edge and the rising edge of the output signal SR₇ᵢ of the flip-flop FF₇ᵢ. In addition, since the output signal SR₇₍ᵢ₊₁₎ is shifted from the output signal SR₇ᵢ by the half clock VCLK cycle, the select signal select[i+1] is shifted from the select signal select[i] by the half clock VCLK cycle.

Referring to FIG. 4B, since the inverted output signal /SR₇ᵢ is output from the flip-flop FF₇ᵢ, the inverted output signal /SR₇ᵢ can be used as the emission control signal emit2[i].

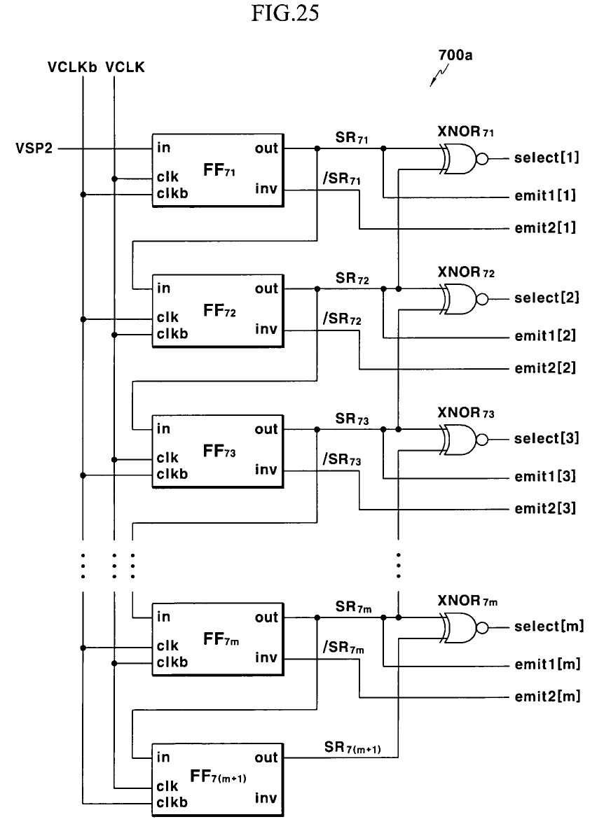

FIG. 25 shows a scan driver 700a in an organic light emitting display according to a tenth exemplary embodiment. Referring to FIG. 25, the scan driver 700a has the same structure as that shown in FIG. 23 except for the inverter INV₇ᵢ. In the scan driver 700a, the output signal SR₇ᵢ and the inverted output signal /SR₇ᵢ of the flip-flop FF₇ᵢ correspond to the emission control signals emit1[i] and emit2[i], respectively.

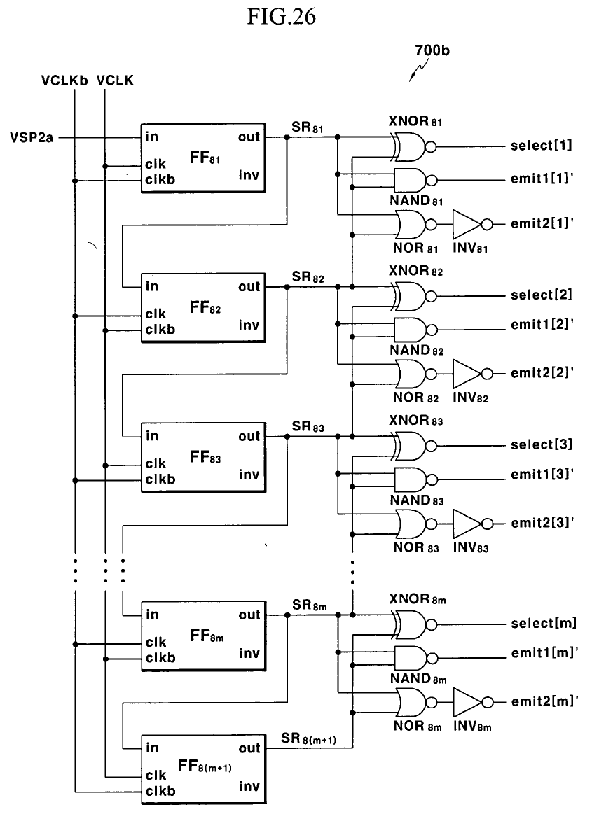

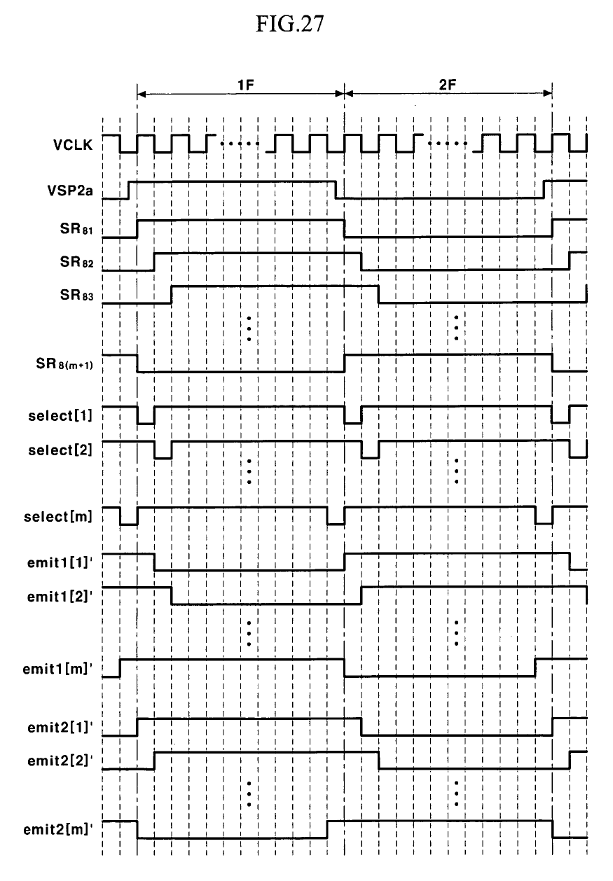

A scan driver 700b for generating the signal timing shown in FIG. 8 will be described with reference to FIGS. 26 and 27. FIG. 26 shows the scan driver 700b in an organic light emitting display according to an eleventh exemplary embodiment, and FIG. 27 shows a signal timing diagram of the scan driver 700b shown in FIG. 26.

As shown in FIG. 16, the scan driver 700b according to the eleventh exemplary embodiment includes (m+1) flip-flops FF₈₁ to FF₈₍ₘ₊₁₎, m XNOR gates XNOR₈₁ to XNOR₈ₘ, m NAND gates NAND₈₁ to NAND₈ₘ, m NOR gates NOR₈₁ to NOR₈ₘ, and m inverters INV₈₁ to INV₈ₘ, and operates as a shift register. Here, the clock VCLK and the start signal VSP2a shown in FIG. 17 are input to the scan driver 700b.

The flip-flop FF₈ᵢ, the NAND gate NAND₈ᵢ, the NOR gate NOR₈ᵢ and the inverter INV₈ᵢ have the same connection and structure as the flip-flop FF₆ᵢ, the NAND gate NAND₆ᵢ, the NOR gate NOR₆ᵢ and the inverter INV₆ᵢ shown in FIG. 16. Accordingly, the NAND gate NAND₈ᵢ performs NAND operation between the output signals SR₈ᵢ, SR₈₍ᵢ₊₁₎ of the flip-flops FF₈ᵢ, FF₈₍ᵢ₊₁₎ to output the emission control signal emit1[i]′ as shown in FIG. 27. The NOR gate NOR₈ᵢ performs a NOR operation between the output signals SR₈ᵢ, SR₈₍ᵢ₊₁₎ of the flip-flops FF₈ᵢ, FF₈₍ᵢ₊₁₎ to output an output signal to the inverter INV₈ᵢ, and the inverter INV₈ᵢ inverts the signal input from the NOR gate NOR₈ᵢ to output the emission control signal emit2[i]′ as shown in FIG. 27.

In addition, the flip-flop FF₈ᵢ and the XNOR gate XNOR₈ᵢ have the same connection as the flip-flop FF₇ᵢ and the XNOR gate XNOR₇ᵢ shown in FIG. 23. Therefore, the XNOR gate XNOR₈ᵢ performs the output signals SR₈ᵢ, SR₈₍ᵢ₊₁₎ of the flip-flops FF₈ᵢ, FF₈₍ᵢ₊₁₎ to output the select signal select[i].

In the eleventh exemplary embodiment, the scan driver 700b uses the start signal VSP2a which is inverted to the start signal VSP2 shown in FIG. 24. However, the scan driver 700b may use the start signal VSP2 shown in FIG. 24. Then, since the output signal of the flip-flop FF₈ᵢ is inverted to the output signal SR₈ᵢ shown in FIG. 27, the output signal of the NAND gate NAND₈ᵢ corresponds to the emission control signal emit2[i]′ and the output signal of the inverter INV₈ᵢ corresponds to the emission control signal emit1[i]′.

In addition, the scan driver 700b may use the inverted output signal of the flip-flop FF₈ᵢ. That is, a NAND gate may be used instead of the NOR gate NOR₈ᵢ and the inverter INV₈ᵢ, and the NAND gate may perform a NAND operation between the inverted output signals of the flip-flops FF₈ᵢ, FF₈₍ⱼ₊₁₎ to output the emission control signal emit2[i]′.

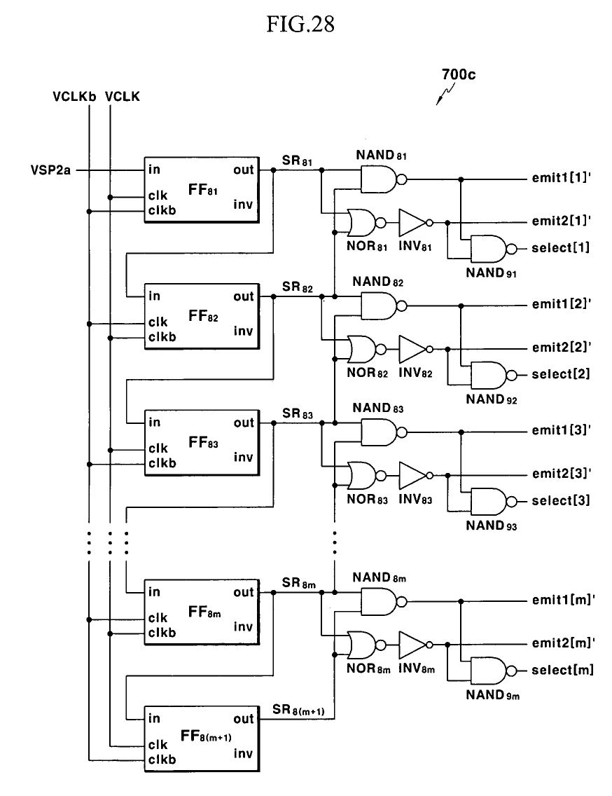

Furthermore, the select signal select[i] may be generated from the emission control signals emit1[i]′, emit2[i]′. This exemplary embodiment will be described with reference to FIG. 28. FIG. 28 shows a scan driver 700c in an organic light emitting display according to a twelfth exemplary embodiment.

As shown in FIG. 28, the scan driver 700c according to the twelfth exemplary embodiment has the same structure as the scan driver 700b shown in FIG. 26 except for a NAND gate NAND₉ᵢ for generating the select signal select[i]. The NAND gate NAND₉ᵢ performs a NAND operation between the emission control signals emit1[i]′, emit2[i]′ to output the select signal select[i].

Referring to FIG. 27, both emission control signals emit1[i]′, emit2[i]′ are high level in the low-level period of the select signal select[i], and one of the emission control signals emit1[i]′, emit2[i]′ is low level in the high-level period of the select signal select[i]. Here, since the output signal of the NAND gate NAND₉ᵢ is the low-level while the both emission control signals emit1[i]′, emit2[i]′ are the high-level, the output signal of the NAND gate NAND₉ᵢ can be used as the select signal select[i].

Also, if the scan driver 700c uses the inverted output signal of the flip-flop FF₈ᵢ, a NAND gate may be used instead of the NOR gate NOR₈ᵢ and the inverter INV₈ᵢ.

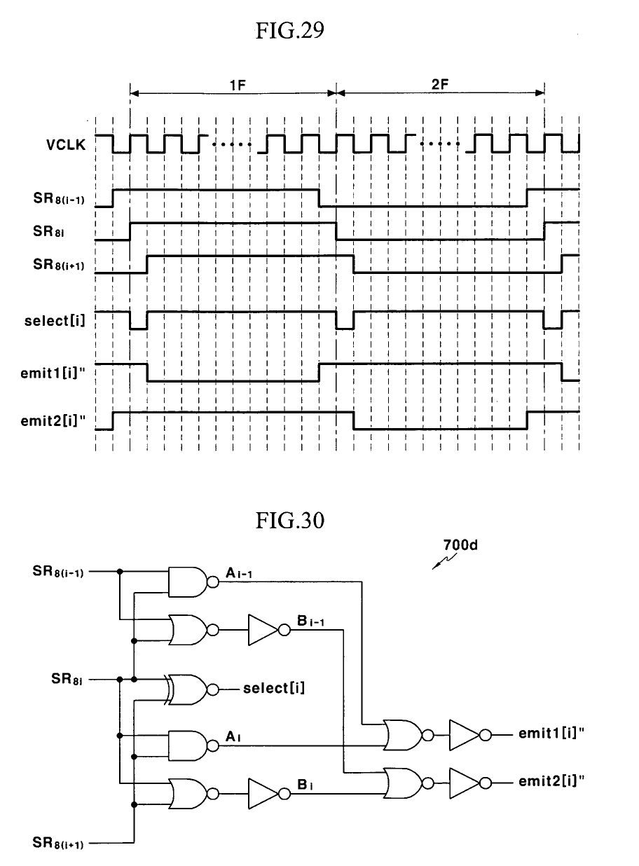

In the eleventh and twelfth exemplary embodiments, the low-level periods of the emission control signals emit1[i]′, emit2[i]′ may be controlled, as shown in FIG. 20. These exemplary embodiments will be described with reference to FIGS. 29 to 32.

First, a thirteenth exemplary embodiment which controls the low-level periods of the emission control signals emit1[i]′, emit2[i]′ in the scan driver 700b shown in FIG. 26 will be described with reference to FIG. 29. FIG. 29 shows a signal timing diagram of the scan driver 700b in an organic light emitting display according to the thirteenth exemplary embodiment.

Referring to FIG. 29, the output signals SR₈₍ᵢ₋₁₎, SR₈₍ᵢ₊₁₎ of the (i−1)^{th} and (i+1)^{th} flip-flops FF₈₍ᵢ₋₁₎, FF₈₍ᵢ₊₁₎ are input to the i^{th} NAND gate NAND₈ᵢ and the i^{th} NOR gate NOR₈ᵢ shown in FIG. 26. Then, the emission control signal emit1[i]″ has the low-level pulse in a period which corresponds to a difference between the subfield 1F and the one clock VCLK cycle, and the emission control signal emit2[i]″ has the low-level pulse in a period which corresponds to a difference between the subfield 2F and the one clock VCLK cycle.

In a like manner, if the output signals SR₈₍ᵢ₋₁₎, SR₈₍ᵢ₊ₖ₎ of the (i−j)^{th} and (i+k)^{th} flip-flops FF₈₍ᵢ₋ⱼ₎, FF₈₍ᵢ₊ₖ₎ (where ‘j’ and ‘k’ are respectively positive integers) are input to the i^{th} NAND gate NAND₈ᵢ and the i^{th} NOR gate NOR₈ᵢ, the low-level periods of the emission control signals emit1[i]″, emit2[i]″ may be controlled by the integral multiple of the half clock VCLK cycle.

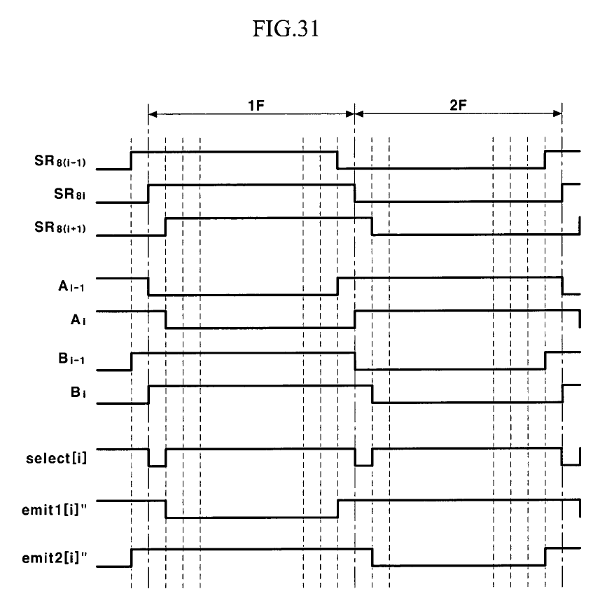

FIG. 30 shows a scan driver 700d in an organic light emitting display according to a fourteenth exemplary embodiment, and FIG. 31 shows a signal timing diagram of the scan driver 700d shown in FIG. 31.

In FIG. 30, the signals SR₈₍ᵢ₋₁₎, SR₈ᵢ, SR₈₍ᵢ₊₁₎ are the output signals of the flip-flops FF₈₍ᵢ₋₁₎, FF₈ᵢ, FF₈₍ᵢ₊₁₎ in the scan driver 700b of FIG. 26, respectively. In addition, two signals Aᵢ, Bᵢ correspond to the emission control signals emit1[i]′, emit2[i]′ of the scan driver 700b, respectively.

Referring to FIGS. 30 and 31, the NAND operation of the output signals SR₈₍ᵢ₋₁₎, SR₈ᵢ of the flip-flops FF₈₍ᵢ₋₁₎, FF₈ᵢ is performed by a NAND gate so that the signal Aᵢ₋₁ is output. The signal Aᵢ₋₁ has the low-level pulse in a period which corresponds to the subfield 1F and the half clock VCLK cycle, and corresponds to the emission control signal emit1[i−1]′ shown in FIG. 27. The OR operation of the output signals SR₈₍ᵢ₋₁₎, SR₈ᵢ of the flip-flops FF₈₍ᵢ₋₁₎, FF₈ᵢ is performed by a NAND gate and an inverter so that the signal Bᵢ₋₁ is output. The signal Bᵢ₋₁ has the low-level pulse in a period which corresponds to the subfield 2F and the half clock VCLK cycle, and corresponds to the emission control signal emit2[i−1]′ shown in FIG. 27. In addition, the signals Aᵢ, Bᵢ respectively correspond to the emission control signals emit1[i]′, emit2[i]′ shown in FIG. 27, and are respectively shifted from the signals Aᵢ₋₁, Bᵢ₋₁ by the half clock VCLK cycle.

Furthermore, the OR operation of the signals Aᵢ₋₁, Aᵢ is performed by a NAND gate and an inverter so that the emission control signal emit1[i]″ is output, and the emission control signal emit1[i]″ has the low-level pulse while both signals Aᵢ₋₁, Aᵢ are low level. The OR operation of the signals Bᵢ₋₁, Bᵢ is performed by a NAND gate and an inverter so that the emission control signal emit2[i]″ is output, and the emission control signal emit2[i]″ has the low-level pulse while both signals Bᵢ₋₁, Bᵢ are low level. The XNOR operation of the output signals SR₈ᵢ, SR₈₍ᵢ₊₁₎ of the flip-flops FF₈ᵢ, FF₈₍ᵢ₊₁₎ is performed so that the select signal select[i] is output.

In FIGS. 30 and 31, if the output signals A₍ᵢ₋ⱼ₎, A₍ᵢ₊ₖ₎ of the (i−j)^{th} and (i+k)^{th} NAND gates (where ‘j’ and ‘k’ are respectively positive integers) are used, the low-level periods of the emission control signals emit1[i]″, emit2[i]″ may be controlled by the integral multiple of the half clock VCLK cycle.

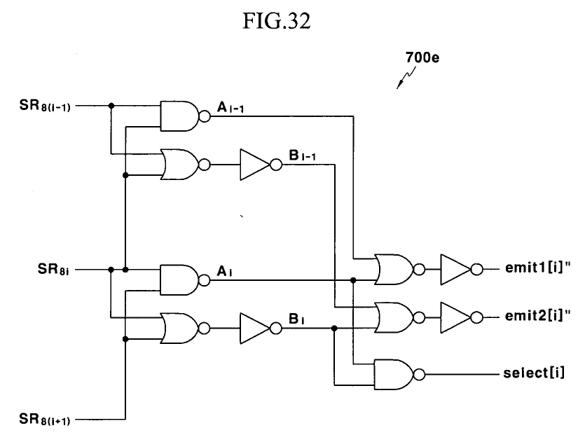

As shown in FIG. 28, the select signal select[i] can be generated by a NAND gate in FIG. 30. This exemplary embodiment will be described with reference to FIG. 32.

FIG. 32 shows a scan driver 700e in an organic light emitting display according to a fifteenth exemplary embodiment. Referring to FIG. 32, the NAND operation of the output signal Aᵢ of the i^{th} NAND gate and the output signal Bᵢ of the i^{th} inverter is performed so that the select signal select[i] is output as shown in FIG. 28.

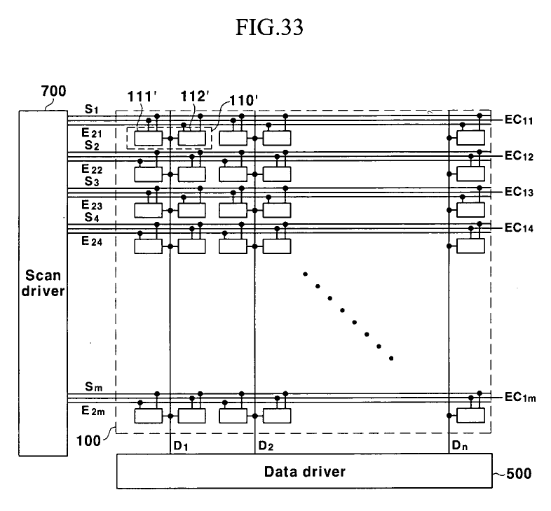

As shown in FIG. 33, the scan driver according to the ninth to fifteenth exemplary embodiments may be applicable to the organic light emitting display shown in FIG. 13. FIG. 33 shows a plan view of the organic light emitting display according to a sixteenth exemplary embodiment of the present invention.

Referring to FIG. 33, as shown in FIG. 13, the emit scan line E₁ᵢ is coupled to the left pixels 111′ of the pixel areas 110′ on the i^{th} row (where ‘i’ is an odd integer of less than ‘m’) and the emit scan line E₂ᵢ is coupled to the right pixels 112′ of the pixel areas 110′ on the i^{th} row, the emit scan line E₁₍ᵢ₊₁₎ is coupled to the right pixels 112′ of the pixel areas 110′ on the (i+1)^{th} row and the emit scan line E₂₍ᵢ₊₁₎ is coupled to the left pixels 112′ of the pixel areas 110′ on the (i+1)^{th} row. In addition, the emit scan lines E₁ᵢ, E₂ᵢ, E₁₍ᵢ₊₁₎, E₂₍ᵢ₊₁₎ are coupled to the scan driver 700.

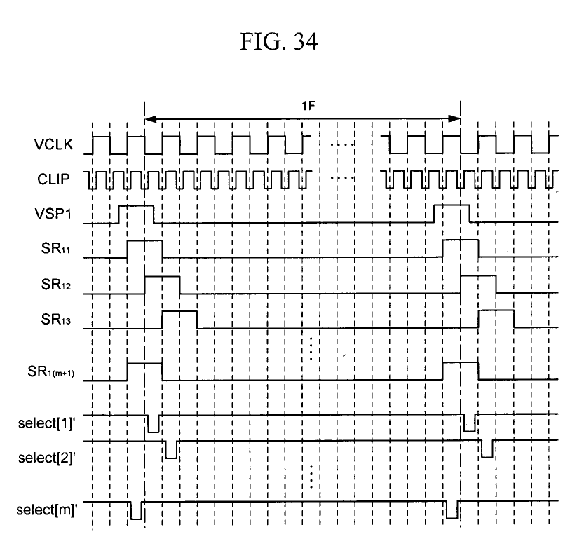

In the above exemplary embodiments, the case in which the rising edge of the select signal select[i−1] corresponds to the falling edge of the select signal select[i] is described, but the falling edge of the select signal select[i] may be apart from the rising edge of the select signal select[i−1]. For example, a clip signal CLIP may be input to the NAND gate NAND₄ᵢ shown in FIG. 4A. As shown in FIG. 34, the clip signal CLIP has a cycle corresponding to the half clock VCLK cycle, and has the low-level pulse whose width is shorter than the half clock VCLK cycle. In addition, the low-level period of the clip signal CLIP includes the falling edge or the rising edge of the clock VCLK. Then, the low-level pulse width of the select signal select[i]′ becomes shorter than the half clock VCLK cycle. That is, the falling edge of the select signal select[i]′ is apart from the rising edge of the select signal select[i−1]′ by the low-level pulse width of the clip signal CLIP.

In the above exemplary embodiments, the case in which the select signal and the emission control signals provided by the scan drivers 200, 300, 400, 600, and/or 700 are directly applied to the select line and the emit lines is shown, but buffers may be formed between the display area 100 and the scan drivers 200, 300, 400, 600, and/or 700. In addition, level shifters which change the levels of the select signal and the emission control signals may be formed between the display area 100 and the scan drivers 200, 300, 400, 600, and/or 700.

According to the exemplary embodiments of the present invention, the two pixels can be driven by common driving and switching transistors and capacitors, thereby reducing the number of data lines. As a result, the number of integrated circuits for driving the data lines can be reduced, and the aperture ratio in the pixel is improved.

While this invention has been described in connection with certain exemplary embodiments, it is to be understood that the invention is not limited to the disclosed embodiments, but, on the contrary, is intended to cover various modifications and equivalent arrangements included within the spirit and scope of the appended claims.

1. A display comprising:
a display area including a plurality of data lines for transmitting data signals for displaying an image, a plurality of first scan lines for transmitting select signals, a plurality of second scan lines and a plurality of third scan lines for respectively transmitting emission control signals, and a plurality of pixel areas, a pixel area including a first pixel and a second pixel coupled to the corresponding data line and the corresponding first scan line; and
a scan driver transmitting first signals to the first scan lines by shifting a first signal having a first pulse in each of a plurality of subfields for forming a field, sequentially transmitting second signals to the second scan lines by shifting a second signal having a second pulse in a first subfield of the plurality of subfields, and transmitting third signals to the third scan lines by shifting a third signal having a third pulse in a second subfield of the plurality of subfields,
wherein the first pixel emits light in response to the second pulse and the second pixel emits light in response to the third pulse.

2. The display of claim 1, wherein a data signal corresponding to the first pixel is transmitted to the corresponding data line when the first pulse is transmitted to the corresponding first scan line in the first subfield, and a data signal corresponding to the second pixel is transmitted to the corresponding data line when the first pulse is transmitted to the corresponding first scan line in the second subfield.

3. The display of claim 1, wherein the scan driver includes a first driver for transmitting the first signals to the first scan lines by shifting the first signal by a first period.

4. The display of claim 3, wherein the first driver includes:
a second driver for outputting fourth signals by shifting a fourth signal by the first period, the fourth signal having a fourth pulse during a second period being longer than the first period in each of the plurality of subfields; and
a third driver for generating a pulse corresponding to the first pulse in at least part of a period during which two fourth signals shifted by the first period have the fourth pulse in common.

5. The display of claim 4, wherein the second driver includes a plurality of flip-flops, an output of a forward flip-flop is an input of a backward flip-flop, and the backward flip-flop outputs the corresponding fourth signal by shifting the fourth signal output from the forward flip-flop by the first period.

6. The display of claim 3, wherein the scan driver includes:
a second driver for transmitting the second signals to the corresponding second scan lines; and
a third driver for transmitting the third signals to the corresponding third scan lines.

7. The display of claim 6, wherein a period during which the second pulse is applied to the second scan line of the corresponding first pixel includes a period during which the first pulse is applied to the first scan line of the corresponding first pixel; and
a period during which the third pulse is applied to the third scan line of the corresponding second pixel includes a period during which the first pulse is applied to the first scan line of the corresponding second pixel.

8. The display of claim 7, wherein the second driver and the third driver respectively include a plurality of flip-flops,
an output of a forward flip-flop is an input of a backward flip-flop,
the backward flip-flop of the second driver outputs a pulse corresponding to the second pulse by shifting a pulse corresponding to the second pulse of the second signal output from the forward flip-flop of the second driver by the first period, and
the backward flip-flop of the third driver outputs a pulse corresponding to the third pulse by shifting a pulse corresponding to the third pulse of the third signal output from the forward flip-flop of the third driver by the first period.

9. The display of claim 6, wherein the second driver transmits the second pulse to the second scan line of the corresponding first pixel after the first pulse transmitted to the first scan line of the corresponding first pixel ends, and
the third driver transmits the third pulse to the third scan line of the corresponding second pixel after the first pulse transmitted to the first scan line of the corresponding second pixel ends.

10. The display of claim 9, wherein the second driver includes:
a fourth driver for outputting fourth signals by shifting a fourth signal by the first period, the fourth signal having a fourth pulse and a fifth pulse inverted to the fourth pulse in a field; and
a fifth driver generating a pulse corresponding to the second pulse in a period during which two fourth signals shifted by the first period have the fourth pulse in common.

11. The display of claim 3, wherein the scan driver further includes a second driver for transmitting the second signals to the corresponding second scan lines by shifting a second signal, and for transmitting the third pulses of the corresponding third signals to the third scan lines by shifting a third signal.

12. The display of claim 11, wherein a period during which the second pulse is applied to the second scan line of the corresponding first pixel includes a period during which the first pulse is applied to the first scan line of the corresponding first pixel, and
a period during which the third pulse is applied to the third scan line of the corresponding second pixel includes a period during which the first pulse is applied to the first scan line of the corresponding second pixel.

13. The display of claim 12, wherein the second driver inverts the second signal to output the third signal.

14. The display of claim 11, wherein the second driver transmits the second pulse to the second scan line of the corresponding first pixel after the first pulse transmitted to the first scan line of the corresponding first pixel ends, and transmits the third pulse of the third signal to the third scan line of the corresponding second pixel after the first pulse transmitted to the first scan line of the corresponding second pixel ends.

15. The display of claim 14, wherein the second driver includes:
a third driver for outputting the fourth signals by shifting a fourth signal by the first period, the fourth signal having a fourth pulse and a fifth pulse inverted to the fourth pulse in a field; and
a fourth driver for generating a pulse corresponding to the second pulse in a period during which two fourth signals shifted by an integral multiple of the first period have the fourth pulse in common.

16. The display of claim 15, wherein the second driver further includes:
a fifth driver for generating a pulse corresponding to the third pulse in a period during which the two fourth signals shifted by an integral multiple of the first period have the fifth pulse in common.

17. The display of claim 15, wherein the fourth driver further outputs a fifth signal inverted to the fourth signal, and
the second driver further includes a fifth driver for generating a pulse corresponding to the third pulse in a period during which two fifth signals shifted by an integral multiple of the first period have the same level as the fourth pulse in common.

18. The display of claim 3, wherein the scan driver includes:
a first driver for outputting fourth signals by shifting a fourth signal, the fourth signal having a fourth pulse and a fifth pulse inverted to the fourth pulse in a field; and
a second driver for generating a pulse corresponding to the first pulse in at least part of a period during which two fourth signals shifted by the first period have the different levels.

19. The display of claim 18, wherein the scan driver generates a pulse corresponding to the second pulse in response to the fourth pulse, and generates a pulse corresponding to the third pulse in response to the fifth pulse.

20. The display of claim 19, wherein a period during which the second pulse is applied to the second scan line of the corresponding first pixel includes a period during which the first pulse is applied to the first scan line of the corresponding first pixel, and
a period during which the third pulse is applied to the third scan line of the corresponding second pixel includes a period during which the first pulse is applied to the first scan line of the corresponding second pixel.

21. The display of claim 18, wherein the scan driver further includes:
a third driver for generating a pulse corresponding to the second pulse in a period during which the two fourth signals shifted by an integral multiple of the first period have the fourth pulse in common; and
a fourth driver for generating a pulse corresponding to the third pulse in a period during which the two fourth signals shifted by an integral multiple of the first period have the fifth pulse in common.

22. The display of claim 18, wherein the scan driver further includes:
a third driver for generating a fifth signal having a sixth pulse in a period during which the two fourth signals shifted by the first period have the fourth pulse in common;
a fourth driver for generating a sixth signal having a seventh pulse in a period during which the two fourth signals shifted by the first period have the fifth pulse in common;
a fifth driver for generating a pulse corresponding to the second pulse in a period during which the two fifth signals shifted by an integral multiple of the first period have the sixth pulse in common; and
a sixth driver for generating a pulse corresponding to the third pulse in a period during which the two sixth signals shifted by an integral multiple of the first period have the seventh pulse in common.

23. The display of claim 3, wherein the scan driver includes:
a first driver for outputting fourth signals by shifting a fourth signal, the fourth signal having a fourth pulse and a fifth pulse inverted to the fourth pulse in a field;
a second driver for generating a pulse corresponding to the second pulse in a period during which two fourth signals shifted by the first period have the fourth pulse in common;
a third driver for generating a pulse corresponding to the third pulse in a period during which the two fourth signals shifted by the first period have the fifth pulse in common; and
a fourth driver for generating a pulse corresponding to the first pulse in at least part of a common period of a period during which the second signal has a pulse inverted to the second pulse and a period during which the third signal has a pulse inverted to the third pulse.

24. The display of claim 3, wherein the scan driver includes:
a first driver for outputting fourth signals by shifting a fourth signal, the fourth signal having a fourth pulse and a fifth pulse inverted to the fourth pulse in a field;
a second driver for generating a fifth signal having a sixth pulse in a period during which two fourth signals shifted by a first integral multiple of the first period have the fourth pulse in common;
a third driver for generating a sixth signal having a seventh pulse in a period during which the two fourth signals shifted by the first integral multiple of the first period have the fourth pulse in common;
a fourth driver for generating a pulse corresponding to the second pulse in a period during which two fifth signals shifted by a second integral multiple of the first period have the sixth pulse in common; and
a fifth driver for generating a pulse corresponding to the third pulse in a period during which two sixth signals shifted by the second integral multiple of the first period have the seventh pulse in common.

25. The display of claim 24, wherein the scan driver further includes:
a sixth driver for generating a pulse corresponding to the first pulse in at least part of a common period of a period during which the second signal has a pulse inverted to the second pulse and a period during which the third signal has a pulse inverted to the third pulse.

26. A display including a plurality of first scan lines for transmitting first signals, a plurality of second scan lines for transmitting second signals, and a plurality of third scan lines for transmitting third signals, the display comprising:
a first driver for outputting the first signals by shifting a first signal by a first period, the first signal having a first pulse during a second period in each of a plurality of subfields forming a field;
a second driver for outputting the second signals by shifting a second signal by the first period, the second signal having a second pulse during a third period longer than the second period in a first subfield of the plurality of subfields; and
a third driver for outputting the third signals by shifting a third signal by the first period, the third signal having a third pulse during a fourth period longer than the second period in a second subfield of the plurality of subfields.

27. The display of claim 26, wherein the first driver includes:
a fourth driver for outputting fourth signals by shifting a fourth signal by the first period, the fourth signal having a fourth pulse in each of the plurality of subfields; and
a fifth driver for generating a pulse corresponding to the first pulse in at least part of a period during which two fourth signals shifted by the first period have a fourth pulse in common.

28. The display of claim 26, wherein the second driver includes:
a fourth driver for outputting fourth signals by shifting the fourth signal by the first period, the fourth signal having a fourth pulse and a fifth pulse inverted to the fourth pulse in a field; and
a fifth driver for generating a pulse corresponding to the second pulse in a period during which the two fourth signal shifted by an integral multiple of the first period have the fourth pulse in common.

29. The display of claim 26, wherein the second driver includes:
a fourth driver for outputting fourth signals by shifting fourth signal by the first period, the fourth signal having a fourth pulse and a fifth pulse inverted to the fourth pulse in a field; and
a fifth driver for generating a pulse corresponding to the second pulse in a period during which at least one of two fourth signals shifted by an integral multiple of the first period has the fourth pulse.

30. The display of claim 26, further comprising:
a plurality of data lines transmitting data signals for displaying an image; and
a plurality of pixel areas,
wherein each of the pixel areas includes:
a pixel driver for programming one of the data signals applied in response to the first pulse of one of the first signals;
a first light emitting element for emitting light corresponding to the programmed data signal in response to the second pulse of one of the second signals; and
a second light emitting element for emitting light corresponding to the programmed data signal in response to the third pulse of one of the third signals.

31. A display including a plurality of first scan lines for transmitting first signals, a plurality of second scan lines for transmitting second signals, and a plurality of third scan lines for transmitting third signals, the display comprising:
a first driver for outputting the first signals by shifting a first signal by a first period, the first signal having a first pulse during a second period in each of a plurality of subfields forming a field; and
a second driver for generating a second signal having a second pulse during a third period longer than the second period in a first subfield of the plurality of subfields and a third signal having a third pulse during a fourth period longer than the second period in a second subfield of the plurality of subfields from a fourth signal, outputting the second signals by shifting the second signal by the first period, and outputting the third signals by shifting the third signal by the first period.

32. The display of claim 31, wherein the first driver includes:
a third driver for outputting fifth signals by shifting a fifth signal by the first period, the fifth signal having a fourth pulse in each of the first and second subfields; and
a fourth driver for generating a pulse corresponding to the first pulse in at least to part of a period during which two fifth signals shifted by the first period have the fourth pulse in common.

33. The display of claim 31, wherein the second driver outputs the fourth signal as the second signal, and inverts the fourth signal to output the third signal.

34. The display of claim 31, wherein the second driver includes:
a third driver for outputting the fourth signals by shifting a fourth signal by the first period, the fourth signal having a fourth pulse and a fifth pulse inverted to the fourth pulse in a field;
a fourth driver for generating a pulse corresponding to the second pulse in a period during which two fourth signals shifted by an integral multiple of the first period have the fourth pulse in common; and
a fifth driver for generating a pulse corresponding to the third pulse in a period during which the two fourth signal shifted by an integral multiple of the first period have the fifth pulse in common.

35. The display of claim 31, further comprising:
a plurality of data lines transmitting data signals for displaying an image; and
a plurality of pixel areas,
wherein each of the pixel areas includes
a pixel driver for programming one of the data signals applied in response to the first pulse of one of the first signals,
a first light emitting element for emitting light corresponding to the programmed data signal in response to the second pulse of one of the second signals, and
a second light emitting element for emitting light corresponding to the programmed data signal in response to the third pulse of one of the third signals.

36. A display including a scan driver for outputting first signals by shifting a first signal by a first period, outputting second signals by shifting a second signal by the first period, and outputting third signals by shifting the first signal by the first period, the scan driver comprising:
a first driver for outputting a plurality of fourth signals by shifting a fourth signal by the first period, the fourth signal having a first pulse and a second pulse inverted to the first pulse in a field; and
a second driver for generating the first signal having a third pulse during a second period in each of a plurality of subfields forming a field, the second signal having a fourth pulse during a third period longer than the second period in a first subfield of the plurality of subfields, and the third signal having a fifth pulse during a fourth period longer than the second period in a second subfield of the plurality of subfields, from a fourth signal.

37. The display of claim 36, wherein the second driver generates a pulse corresponding to the third pulse in at least part of a period during which the two fourth signals shifted by the first period have different levels.

38. The display of claim 36, wherein the second driver outputs the fourth signal as the second signal, and inverts the fourth signal to output the third signal.

39. The display of claim 36, wherein the second driver includes:
a third driver for generating a pulse corresponding to the fourth pulse in a period during which two fourth signals shifted by an integral multiple of the first period have the first pulse in common; and
a fourth driver for generating a pulse corresponding to the fifth pulse in a period during which the two fourth signals shifted by an integral multiple of the first period have the second pulse in common.

40. The display of claim 39, wherein the second driver further includes a fifth driver for generating a pulse corresponding to the third pulse in at least part of a period during which the second signal and the third signal have the same levels, and
the integral multiple is a multiple of one.

41. The display of claim 36, wherein the second driver includes:
a third driver for generating a fifth signal having a sixth pulse in a period during which two fourth signals shifted by a first integral multiple of the first period have the first pulse in common, and generating a sixth signal having a seventh pulse in a period during which the two fourth signals shifted by the first integral multiple of the first period have the second pulse in common; and
a fourth driver for generating a pulse corresponding to the fourth pulse in a period during which two fifth signals shifted by a second integral multiple of the first period have the sixth pulse in common, and generating a pulse corresponding to the fifth pulse in a period during which two sixth signals shifted by the second integral multiple of the first period have the seventh pulse in common.

42. The display of claim 41, wherein the second driver further includes a fifth driver for generating a pulse corresponding to the third pulse at least part of a period during which the fifth signal and the sixth signal have the same levels.

43. The display of claim 36, further comprising:
a plurality of data lines transmitting data signals for displaying an image; and
a plurality of pixel areas,
wherein each of the pixel areas includes
a pixel driver for programming one of the data signals applied in response to the third pulse of one of the first signals,
a first light emitting element for emitting light corresponding to the programmed data signal in response to the fourth pulse of one of the second signals, and
a second light emitting element for emitting light corresponding to the programmed data signal in response to the fifth pulse of one of the third signals.

44. A driving method of a display including a first scan line, a second scan line, a third scan line, a data line transmitting a data signal for displaying a image, and a pixel area defined by the first, second, and third scan lines, and the data line, the driving method comprising:
outputting a select signal having a first pulse during a first period in each of a plurality of subfields forming a field;
outputting a first emission control signal having a second pulse during a second period longer than the first period in a first subfield of the plurality of subfields; and
outputting a second emission control signal having a third pulse during a third period longer than the first period in a second subfield of the plurality of subfields,
wherein the data signal is programmed to the pixel area in response to a pulse corresponding to the first pulse transmitted to the first scan line, a first pixel of the pixel area starts emitting light corresponding to the programmed data signal in response to a pulse corresponding to the second pulse transmitted to the second scan line, and a second pixel of the pixel area starts emitting light corresponding to the programmed data signal in response to a pulse corresponding to the third pulse transmitted to the third scan line.

45. The driving method of claim 44, further comprising:
outputting first signals by shifting a first signal by a fourth period, a fourth signal having a fourth pulse in each of the plurality of subfields; and
generating the first pulse in at least part of a period during which the two first signals shifted by the fourth period have the fourth pulse in common.

46. The driving method of claim 44, wherein the second emission control signal corresponds to a signal inverted to the first emission control signal.

47. The driving method of claim 44, further comprising:
outputting first signals by shifting a first signal by a fourth period, the first signal having a fourth pulse and a fifth pulse inverted to the fourth pulse in a field; and
generating the second pulse in a period during which the two first signals shifted by an integral multiple of the fourth period have the fourth pulse in common.

48. The driving method of claim 47, further comprising:
generating the third pulse in a period during which the two first signals shifted by an integral multiple of the fourth period have the fifth pulse in common.

49. The driving method of claim 47, further comprising:
generating the first pulse in at least part of a period during which the two first signals shifted by the fourth period have the different levels.

50. The driving method of claim 47, further comprising:
generating the first pulse in at least part of a common period of a period during which the first emission control signal has an inverted pulse to the second pulse and a period during which the second emission control signal has an inverted pulse to the third pulse,
wherein the integral multiple is a multiple of one.

51. The driving method of claim 44, further comprising:
outputting first signals by shifting the first signal by a fourth period, the first signal having a fourth pulse and a fifth pulse inverted to the fourth pulse in a field; and
generating the second pulse in a period during which at least one of the two first signals shifted by an integral multiple of the fourth period has the fourth pulse.

52. The driving method of claim 44, further comprising:
outputting first signals by shifting the first signal by a fourth period, the first signal having a fourth pulse and a fifth pulse inverted to the fourth pulse in a field;
generating the second pulse in a period during which the two first signals shifted by the fourth period have different levels; and
generating the second pulse and the third pulse in response to the fourth pulse and the fifth pulse, respectively.
